(19) United States
(12) Patent Application Publication
(10) Pub. No.: US 2024/0336846 A1
(43) Pub. Date: Oct. 10, 2024

(54) Polymer Composition for Use in an Electronic Device

(71) Applicant: Ticona LLC, Florence, KY (US)

(72) Inventor: Young Shin Kim, Cincinnati, OH (US)

(21) Appl. No.: 18/617,712

(22) Filed: Mar. 27, 2024

Related U.S. Application Data
(60) Provisional application No. 63/494,815, filed on Apr. 7, 2023.

(51) Int. Cl. C09K 19/38; C09K 19/52; H01B 3/42

(52) U.S. Cl. CPC C09K 19/3838; H01B 3/423; C09K 2019/521

(57) ABSTRACT

A polymer composition is disclosed that comprises carbon particles, a dielectric filler, and a polymer matrix containing at least one thermotropic liquid crystalline polymer is provided. The polymer composition exhibits a dissipation factor of about 0.02 or less as determined at a frequency of 5 GHz, a dielectric constant of about 8.5 or more as determined at a frequency of 5 GHz.

### RELATED APPLICATION

The present application is based upon and claims priority to U.S. Provisional Patent Application Ser. No. 63/494,815, having a filing date of Apr. 7, 2023, which is incorporated herein by reference.

### BACKGROUND OF THE INVENTION

Various types of electrical components will be employed in 5G systems, such as antenna elements. Unfortunately, transmitting and receiving at the high frequencies encountered in a 5G application generally results in an increased amount of power consumption and heat generation. As a result, the materials often used in conventional electronic components can negatively impact high frequency performance capabilities. As such, a need exists for improved electronic components for use in 5G antenna systems.

### SUMMARY OF THE INVENTION

In accordance with one embodiment of the present invention, a polymer composition is disclosed that comprises 100 parts by weight of a polymer matrix that contains a thermotropic liquid crystalline polymer, from about 8 to about 30 parts by weight of carbon particles, and from about 80 to about 220 parts by weight of a dielectric filler. The polymer composition further exhibits a dissipation factor of about 0.02 or less as determined at a frequency of 5 GHz and a dielectric constant of about 8.5 or more as determined at a frequency of 5 GHz.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a perspective view of one embodiment of an electronic device that may employ the polymer composition of the present invention;

FIG. 2 is a schematic diagram of one embodiment of an electronic device that may be employed with wireless communications circuitry;

FIG. 3 is a diagram of one embodiment of a phased antenna array that may be adjusted using control circuitry to direct a beam of signals;

FIG. 4 is a perspective view of one embodiment of a patch antenna that may employ the polymer composition of the present invention;

FIG. 5 is a side view of one embodiment of an electronic device having cover layers;

FIG. 6 is a cross-sectional side view of one embodiment of a phased antenna array that may be mounted against a cover layer; and

FIG. 7 is a top-down view of one embodiment of a phased antenna array having a repeating pattern of antenna unit cells.

### DETAILED DESCRIPTION

It is to be understood by one of ordinary skill in the art that the present discussion is a description of exemplary embodiments only, and is not intended as limiting the broader aspects of the present invention.

Generally speaking, the present disclosure is directed to a polymer composition that contains a combination of carbon particles and a dielectric filler distributed within a polymer matrix containing at least one thermotropic liquid crystalline polymer. By selectively controlling various aspects of the composition, the present inventor has discovered that the resulting composition is able to maintain a unique combination of a high dielectric constant and low dissipation factor for use in a dielectric layer, such as one employing a phased antenna array. For example, the polymer composition may exhibit a high dielectric constant of about 8.5 or more, in some embodiments about 9 or more, in some embodiments from about 10 to about 30, in some embodiments from about 11 to about 25, and in some embodiments, from about 12 to about 24, as determined by the split post resonator method at a frequency of 5 GHz. Such a high dielectric constant can facilitate the ability to form a thin layer and also allow multiple conductive elements (e.g., antennae) to be employed that operate simultaneously with only a minimal level of electrical interference. The dissipation factor, a measure of the loss rate of energy, may also be relatively low, such as about 0.02 or less, in some embodiments about 0.01 or less, in some embodiments about 0.009 or less, in some embodiments about 0.008 or less, and in some embodiments, from about 0.0001 to about 0.007, as determined by the split post resonator method at a frequency of 5 GHz. Notably, the present inventor has also surprisingly discovered that the dielectric constant and dissipation factor can be maintained within the ranges noted above even when exposed to various temperatures, such as a temperature of from about −30° C. to about 100° C. For example, when subjected to a heat cycle test as described herein, the ratio of the dielectric constant after heat cycling to the initial dielectric constant may be about 0.8 or more, in some embodiments about 0.9 or more, and in some embodiments, from about 0.95 to about 1.1. Likewise, the ratio of the dissipation factor after being exposed to the high temperature to the initial dissipation factor may be about 1.3 or less, in some embodiments about 1.2 or less, in some embodiments about 1.1 or less, in some embodiments about 1.0 or less, in some embodiments about 0.95 or less, in some embodiments from about 0.1 to about 0.95, and in some embodiments, from about 0.2 to about 0.9. The change in dissipation factor (i.e., the initial dissipation factor−the dissipation factor after heat cycling) may also range from about −0.1 to about 0.1, in some embodiments from about −0.05 to about 0.01, and in some embodiments, from about −0.001 to 0.

Conventionally, it was believed that polymer compositions that possess the combination of a high dielectric constant and low dissipation factor would not also possess a sufficiently low melt viscosity to so that it can readily flow into the cavity of a mold to form a small-sized dielectric layer. Contrary to conventional thought, however, the polymer composition has been found to possess excellent melt processability. For example, the polymer composition may have an ultralow melt viscosity, such as from about 0.1 to about 100 Pa-s, in some embodiments from about 0.2 to about 75 Pa-s, in some embodiments from about 0.5 to about 65 Pa-s, in some embodiments from about 0.1 to about 50 Pa-s, in some embodiments from about 0.2 to about 45 Pa-s, in some embodiments from about 0.5 to about 40 Pa-s, and in some embodiments, from about 1 to about 35 Pa-s, determined at a shear rate of 1,000 seconds⁻¹ and temperature of about 15° C. greater than the melting temperature of the polymer composition in accordance with ISO 11443:2021.

The polymer composition also has excellent thermal properties. The melting temperature of the composition may, for instance, be from about 280° C. to about 400° C., in some embodiments from about 290° C. to about 380° C., and in some embodiments, from about 300° C. to about 350° C. Even at such melting temperatures, the ratio of the deflection temperature under load (“DTUL”), a measure of short term heat resistance, to the melting temperature may still remain relatively high. For example, the ratio may range from about 0.5 to about 1.00, in some embodiments from about 0.6 to about 0.95, and in some embodiments, from about 0.65 to about 0.85. The specific DTUL values may, for instance, be about 200° C. or more, in some embodiments about 220° C. or more, in some embodiments from about 230° C. to about 300° C., and in some embodiments, from about 240° C. to about 280° C. Such high DTUL values can, among other things, allow the use of high speed and reliable surface mounting processes for mating the structure with other components of the electrical component.

The polymer composition may also possess a high impact strength, which is useful when forming thin layers. The composition may, for instance, possess a Charpy notched impact strength of about 0.5 kJ/m² or more, in some embodiments from about 1 to about 60 kJ/m², in some embodiments from about 2 to about 50 kJ/m², and in some embodiments, from about 5 to about 45 kJ/m², as determined at a temperature of 23° C. in accordance with ISO Test No. ISO 179-1:2010. The tensile and flexural mechanical properties of the composition may also be good. For example, the polymer composition may exhibit a tensile strength of from about 20 to about 500 MPa, in some embodiments from about 50 to about 400 MPa, and in some embodiments, from about 70 to about 350 MPa; a tensile break strain of about 0.4% or more, in some embodiments from about 0.5% to about 10%, and in some embodiments, from about 0.6% to about 3.5%; and/or a tensile modulus of from about 5,000 MPa to about 20,000 MPa, in some embodiments from about 8,000 MPa to about 20,000 MPa, and in some embodiments, from about 10,000 MPa to about 20,000 MPa. The tensile properties may be determined at a temperature of 23° C. in accordance with ISO Test No. 527:2019. The polymer composition may also exhibit a flexural strength of from about 20 to about 500 MPa, in some embodiments from about 50 to about 400 MPa, and in some embodiments, from about 100 to about 350 MPa; a flexural elongation of about 0.4% or more, in some embodiments from about 0.5% to about 10%, and in some embodiments, from about 0.6% to about 3.5%; and/or a flexural modulus of from about 5,000 MPa to about 20,000 MPa, in some embodiments from about 8,000 MPa to about 20,000 MPa, and in some embodiments, from about 10,000 MPa to about 15,000 MPa. The flexural properties may be determined at a temperature of 23° C. in accordance with 178:2019.

Various embodiments of the present invention will now be described in more detail.

### I. Polymer Composition

### A. Polymer Matrix

The polymer matrix contains one or more thermotropic liquid crystalline polymers and constitutes from about 20 wt. % to about 70 wt. %, in some embodiments from about 25 wt. % to about 60 wt. %, and in some embodiments, from about 30 wt. % to about 50 wt. % of the polymer composition. Liquid crystalline polymers are generally classified as “thermotropic” to the extent that they can possess a rod-like structure and exhibit a crystalline behavior in their molten state (e.g., thermotropic nematic state). The liquid crystalline polymers employed in the polymer composition typically have a melting temperature of from about 280° C. to about 400° C., in some embodiments from about 290° C. to about 380° C., and in some embodiments from about 300° C. to about 350° C. The melting temperature may be determined as is well known in the art using differential scanning calorimetry (“DSC”), such as determined by ISO 11357-3:2018. Such polymers may be formed from one or more types of repeating units as is known in the art. A liquid crystalline polymer may, for example, contain one or more aromatic ester repeating units generally represented by the following Formula (I):

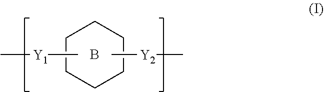

wherein,
ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and
Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic hydroxycarboxylic repeating units, for instance, may be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute from about 20 mol. % to about 85 mol. %, in some embodiments from about 30 mol. % to about 80 mol. %, and in some embodiments, from about 40 mol. % to 75 mol. % of the polymer.

Aromatic dicarboxylic repeating units may also be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) typically constitute from about 1 mol. % to about 50 mol. %, in some embodiments from about 5 mol. % to about 40 mol. %, and in some embodiments, from about 10 mol. % to about 35 mol. % of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about 1 mol. % to about 50 mol. %, in some embodiments from about 5 mol. % to about 40 mol. %, and in some embodiments, from about 10 mol. % to about 35 mol. % of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10% of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

Although not necessarily required, at least one liquid crystalline polymer is typically employed in the polymer matrix that is a “high naphthenic” polymer to the extent that it contains a relatively high content of repeating units derived from naphthenic hydroxycarboxylic acids and naphthenic dicarboxylic acids, such as NDA, HNA, or combinations thereof. That is, the total amount of repeating units derived from naphthenic hydroxycarboxylic and/or dicarboxylic acids (e.g., NDA, HNA, or a combination of HNA and NDA) is typically about 10 mol. % or more, in some embodiments about 15 mol. % or more, in some embodiments from about 20 mol. % to about 80 mol. %, in some embodiments from about 30 mol. % to about 70 mol. %, and in some embodiments, from about 40 mol. % to about 60 mol. % of the polymer. Contrary to many conventional “low naphthenic” polymers, it is believed that the resulting “high naphthenic” polymers are capable of exhibiting good thermal and mechanical properties.

In one particular embodiment, for instance, the liquid crystalline polymer may contain repeating units derived from HNA in an amount from 20 mol. % to about 80 mol. %, in some embodiments from about 30 mol. % to about 70 mol. %, and in some embodiments, from about 40 mol. % to about 60 mol. %. The liquid crystalline polymer may also contain various other monomers. For example, the polymer may contain repeating units derived from HBA in an amount of from about 0.1 mol. % to about 15 mol. %, and in some embodiments from about 0.5 mol. % to about 10 mol. %, and in some embodiments, from about 1 mol. % to about 5 mol. %. When employed, the molar ratio of repeating units derived from HBA to the repeating units derived from HNA may be selectively controlled within a specific range to help achieve the desired properties, such as from about 5 to about 40, in some embodiments from about 10 to about 35, and in some embodiments, from about 20 to about 30. The polymer may also contain repeating units derived from aromatic dicarboxylic acid(s) (e.g., IA and/or TA) in an amount of from about 10 mol. % to about 40 mol. %, and in some embodiments, from about 20 mol. % to about 30 mol. %; and/or aromatic diol(s) (e.g., BP and/or HQ) in an amount of from about 10 mol. % to about 40 mol. %, and in some embodiments, from about 20 mol. % to about 30 mol. %. In some cases, however, it may be desired to minimize the presence of such monomers in the polymer to help achieve the desired properties. For example, the total amount of repeating units derived from aromatic dicarboxylic acid(s) (e.g., IA and/or TA) and/or aromatic diols (e.g., BP and/or HQ) may be about 5 mol % or less, in some embodiments about 4 mol. % or less, and in some embodiments, from about 0.1 mol. % to about 3 mol. %, of the polymer. In another embodiment, the repeating units derived from naphthalene-2,6-dicarboxylic acid (“NDA”) may constitute from about 10 mol. % to about 40 mol. %, in some embodiments from about 12 mol. % to about 35 mol. %, and in some embodiments, from about 15 mol. % to about 30 mol. % of the polymer. In such embodiments, the liquid crystalline polymer may also contain various other monomers, such as aromatic hydroxycarboxylic acid(s) (e.g., HBA) in an amount of from about 20 mol. % to about 60 mol. %, and in some embodiments, from about 30 mol. % to about 50 mol. %; aromatic dicarboxylic acid(s) (e.g., IA and/or TA) in an amount of from about 2 mol. % to about 30 mol. %, and in some embodiments, from about 5 mol. % to about 25 mol. %; and/or aromatic diol(s) (e.g., BP and/or HQ) in an amount of from about 2 mol. % to about 40 mol. %, and in some embodiments, from about 5 mol. % to about 35 mol. %.

Regardless of the particular constituents and nature of the polymer, the liquid crystalline polymer may be prepared by initially introducing the aromatic monomer(s) used to form the ester repeating units (e.g., aromatic hydroxycarboxylic acid, aromatic dicarboxylic acid, etc.) and/or other repeating units (e.g., aromatic diol, aromatic amide, aromatic amine, etc.) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, III, et al.; U.S. Pat. No. 6,114,492 to Linstid, III, et al.; U.S. Pat. No. 6,514,611 to Shepherd, et al.; and WO 2004/058851 to Waqqoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation.

In addition to the monomers and optional acetylating agents, other components may also be included within the reaction mixture to help facilitate polymerization. For instance, a catalyst may be optionally employed, such as metal salt catalysts (e.g., magnesium acetate, tin(I) acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 200° C. to about 400° C. For instance, one suitable technique for forming the aromatic polyester may include charging precursor monomers and acetic anhydride into the reactor, heating the mixture to a temperature of from about 90° C. to about 150° C. to acetylize a hydroxyl group of the monomers (e.g., forming acetoxy), and then increasing the temperature to from about 200° C. to about 400° C. to carry out melt polycondensation. As the final polymerization temperatures are approached, volatile byproducts of the reaction (e.g., acetic acid) may also be removed so that the desired molecular weight may be readily achieved. The reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

Following melt polymerization, the molten polymer may be discharged from the reactor, typically through an extrusion orifice fitted with a die of desired configuration, cooled, and collected. Commonly, the melt is discharged through a perforated die to form strands that are taken up in a water bath, pelletized and dried. In some embodiments, the melt polymerized polymer may also be subjected to a subsequent solid-state polymerization method to further increase its molecular weight. Solid-state polymerization may be conducted in the presence of a gas (e.g., air, inert gas, etc.). Suitable inert gases may include, for instance, include nitrogen, helium, argon, neon, krypton, xenon, etc., as well as combinations thereof. The solid-state polymerization reactor vessel can be of virtually any design that will allow the polymer to be maintained at the desired solid-state polymerization temperature for the desired residence time. Examples of such vessels can be those that have a fixed bed, static bed, moving bed, fluidized bed, etc. The temperature at which solid-state polymerization is performed may vary, but is typically within a range of from about 200° C. to about 400° C. The polymerization time will of course vary based on the temperature and target molecular weight. In most cases, however, the solid-state polymerization time will be from about 2 to about 12 hours, and in some embodiments, from about 4 to about 10 hours.

The total amount of liquid crystalline polymers employed in the polymer composition is typically from about 30 wt. % to about 90 wt. %, in some embodiments from about 35 wt. % to about 80 wt. %, and in some embodiments, from about 40 wt. % to about 60 wt. % of the entire polymer composition. In certain embodiments, all of the liquid crystalline polymers are “high naphthenic” polymers such as described above. In other embodiments, however, “low naphthenic” liquid crystalline polymers may also be employed in the composition in which the total amount of repeating units derived from naphthenic hydroxycarboxylic and/or dicarboxylic acids (e.g., NDA, HNA, or a combination of HNA and NDA) is less than 10 mol. %, in some embodiments about 8 mol. % or less, in some embodiments about 6 mol. % or less, and in some embodiments, from about 1 mol. % to about 5 mol. % of the polymer. When employed, it is generally desired that such low naphthenic polymers are present in only a relatively low amount. For example, when employed, low naphthenic liquid crystalline polymers typically constitute from about 0.001 wt. % to about 20 wt. %, in some embodiments from about 0.01 wt. % to about 10 wt. %, and in some embodiments, and in some embodiments, from about 0.02 wt. % to about 5 wt. % of the polymer matrix. Conversely, high naphthenic liquid crystalline polymers typically constitute from about 80 wt. % to about 99.999 wt. %, in some embodiments from about 90 wt. % to about 99.9 wt. %, and in some embodiments, from about 95 wt. % to about 99.8 wt. % of the polymer matrix.

### B. Carbon Particles

As noted above, carbon particles are also employed in the polymer composition and can be distributed throughout the polymer matrix. The carbon particles typically constitute from about 8 to about 30 parts by weight, in some embodiments from about 10 to about 25 parts by weight, in some embodiments from about 11 to about 22 parts by weight, and in some embodiments, from about 12 to about 20 parts by weight per 100 parts by weight of the polymer matrix. The carbon particles may likewise constitute from about 3 wt. % to about 20 wt. %, in some embodiments from 4 wt. % to about 15 wt. %, and in some embodiments, from about 5 wt. % to about 10 wt. % of the entire polymer composition.

A variety of carbon particles may generally be employed in the polymer composition. In certain embodiments, for instance, the carbon particles may be carbon black particles, such as those formed from channel carbon black, furnace carbon black, lamp carbon black, and thermal carbon black. Preferably, the carbon black particles are not coated and/or do not contain carbon nanotubes. Regardless of the type of particles employed, it is generally desired that the particles are insulative in nature and thus exhibit a relatively low electrical conductivity. Without intending to be limited by theory, it is believed that the use of insulative carbon particles can help achieve a lower dissipation factor. For example, the carbon particles may exhibit a surface resistivity of about 1×10² ohms or greater, in some embodiments about 1×10¹² ohms or greater, in some embodiments from about 1×10¹⁵ ohms to about 1×10¹⁸ ohms, and in some embodiments, from about 1×10¹⁶ ohms to about 1×10¹⁷ ohms. For example, when the carbon particles are contained in a liquid crystalline polymer masterbatch in an amount of 50 wt. %, the masterbatch can exhibit a surface resistivity of about 1×10² ohms or greater, in some embodiments about 1×10³ ohms or greater, in some embodiments from about 1×10⁴ ohms to about 1×10⁸ ohms, and in some embodiments, from about 1×10⁵ ohms to about 1×10⁶ ohms.

The carbon particles typically exist in the form of agglomerates of primary particles. In this regard, the carbon particles may have a primary particle size and a secondary particle size, where the primary particle size represents the smallest visibly distinct particles when viewed at a 20000-fold magnification level and the secondary particle size represents the particle size of the carbon agglomerates, which are dispersed in the polymer matrix. In some embodiments, the carbon black particles have a number average primary particle size from about 5 nm to about 100 nm, in some embodiments from about 20 nm to about 70 nm, in some embodiments from about 30 nm to about 60 nm, and in some embodiments, from about 35 nm to about 45 nm. In some embodiments, the number average secondary particle size of the carbon particles can be from about 1 μm to about 100 μm, in some embodiments from about 5 μm to about 50 μm, and in some embodiments from about 10 μm to about 30 μm. The number average primary and secondary particle sizes can be determined according to ASTM D3849-22. The specific surface area of the carbon particles is not particularly limited, but in some embodiments may range from about 50 m²/g to about 1500 m²/g and in some embodiments from about 100 m²/g to about 1250 m²/g. The surface area can be determined by BET analysis, for example, according to ASTM D6556-21. The pH of an aqueous dispersion of the carbon particles at 25° C. can, in some embodiments, be from about 2.0 to about 8.5, in some embodiments from about 2.5 to about 7.5, and in some embodiments, from about 3.5 to about 6, The pH of a carbon particle dispersion of pre-determined concentration can be measured with any suitably calibrated pH-meter equipment, for instance, according to ISO 787-9.

### C. Dielectric Filler

To help achieve the desired dielectric properties, the polymer composition also generally contains a dielectric filler. The dielectric filler typically constitutes from about 80 to about 220 parts by weight, in some embodiments from about 95 to about 200 parts by weight, in some embodiments from about 100 to about 180 parts by weight, and in some embodiments, from about 110 to about 160 parts by weight per 100 parts by weight of the polymer matrix. The dielectric filler may likewise constitute from about 10 wt. % to about 65 wt. %, in some embodiments from 20 wt. % to about 60 wt. %, and in some embodiments, from about 35 wt. % to about 55 wt. % of the entire polymer composition.

In certain embodiments, it may be desirable to selectively control the electrical properties of the dielectric filler to help achieve the desired results. For example, the dielectric constant of the material may be about 20 or more, ins some embodiments about 40 or more, and in some embodiments, about 50 more as determined at a frequency of 1 MHz. High dielectric constant materials may be employed in certain embodiments, such as from about 1,000 to about 15,000, in some embodiments from about 3,500 to about 12,000, and in some embodiments, from about 5,000 to about 10,000, as determined at a frequency of 1 MHz. In other embodiments, mid-range dielectric constant materials may be employed, such as from about 20 to about 200, in some embodiments from about 40 to about 150, and in some embodiments, from about 50 to about 100, as determined at a frequency of 1 MHz. The volume resistivity of the dielectric filler may likewise range from about 1×10¹¹ to about 1×10²⁰ ohm-cm, in some embodiments from about 1×10¹² to about 1×10¹⁹ ohm-cm, and in some embodiments, from about 1×10¹³ to about 1×10¹⁸ ohm-cm, such as determined at a temperature of about 20° C. in accordance with ASTM D257-14. The desired properties may be accomplished by selecting a single material having the target volume dielectric constant and/or volume resistivity, or by blending multiple materials together (e.g., insulative and electrically conductive) so that the resulting blend has the desired properties.

Particularly dielectric fillers are inorganic dielectric fillers, such as those formed from an inorganic oxide material. Suitable inorganic oxide materials may include, for instance, ferroelectric and/or paraelectric materials. Examples of suitable ferroelectric materials include, for instance, barium titanate (BaTiO₃), strontium titanate (SrTiO₃), calcium titanate (CaTiO₃), magnesium titanate (MgTiO₃), strontium barium titanate (SrBaTiO₃), sodium barium niobate (NaBa₂Nb₅O₁₅), potassium barium niobate (KBa₂Nb₅O₁₅), calcium zirconate (CaZrO₃), titanite (CaTiSiO₅), as well as combinations thereof. Examples of suitable paraelectric materials likewise include, for instance, titanium dioxide (TiO₂), tantalum pentoxide (Ta₂O₅), hafnium dioxide (HfO₂), niobium pentoxide (Nb₂O₅), alumina (Al₂O₃), zinc oxide (ZnO), etc., as well as combinations thereof. Particularly suitable inorganic oxide materials are particles that include TiO₂, BaTiO₃, SrTiO₃, CaTiO₃, MgTiO₃, BaSrTi₂O₆, and ZnO. Of course, other types of inorganic oxide materials (e.g., mica) may also be employed as a dielectric filler.

The dielectric filler may be employed in a variety of different forms, such as particles, fibers, whiskers, etc. Particles may, for instance, be particularly suitable. The particles may have a variety of different shapes and/or sizes. For instance, the particles may be spherical, ovular, plate-shaped, flake-like, spindle-shaped, cubic-shaped, columnar-shaped, etc., as well as random variations and blends thereof. The average diameter of the particles may also vary, such as from about 0.01 to about 50 micrometers, in some embodiments from about 0.05 to about 10 micrometers, and in some embodiments, from about 0.1 to about 1 micrometer.

In one particular embodiment, titanium dioxide (TiO₂) particles may be employed in the polymer composition as a dielectric filler. The particles may be in the rutile or anatase crystalline form, although rutile is particularly suitable due to its higher density and tint strength. Rutile titanium dioxide is commonly made by either a chloride process or a sulfate process. In the chloride process, TiCl₄ is oxidized to TiO₂ particles. In the sulfate process, sulfuric acid and ore containing titanium are dissolved, and the resulting solution goes through a series of steps to yield TiO₂. Preferably, the titanium dioxide particles may be in the rutile crystalline form and made using the chloride process. The titanium dioxide particles may be substantially pure titanium dioxide or may contain other metal oxides, such as silica, alumina, zirconia, etc. Other metal oxides may be incorporated into the particles, for example, by co-oxidizing or co-precipitating titanium compounds with other metal compounds, such as metal halides of silicon, aluminum and zirconium. If co-oxidized or co-precipitated metals are present, they are typically present in an amount 0.1 to 5 wt. % as the metal oxide based on the weight of the titanium dioxide particles. When alumina is incorporated into the particles by co-oxidation of aluminum halide (e.g., aluminum chloride), alumina is typically present in an amount from about 0.5 to about 5 wt. %, and in some embodiments, from about 0.5 to about 1.5 wt. % based on the total weight of the particles. The titanium dioxide particles may also be coated with an inorganic oxide (e.g., alumina), organic compound, or a combination thereof. Such coatings may be applied using a surface wet treatment technique and/or oxidation technique as are known by those skilled in the art. In one embodiment, for example, the titanium dioxide particles may contain a coating that includes alumina, such as in an amount of from about 0.5 to about 5 wt. %, and in some embodiments, from about 1 to about 3 wt. % of the coating.

### D. Optional Additives

i. Mineral Filler

The polymer composition may also optionally contain one or more mineral fillers distributed within the polymer matrix. When employed, such mineral filler(s) typically constitute from about 1 wt. % to about 50 wt. %, in some embodiments from about 2 wt. % to about 45 wt. %, and in some embodiments, from about 5 wt. % to about 40 wt. % of the polymer composition. The nature of the mineral filler(s) employed in the polymer composition may vary, such as mineral particles, mineral fibers (or “whiskers”), etc., as well as blends thereof. Typically, the mineral filler(s) employed in the polymer composition have a certain hardness value to help improve the mechanical strength, adhesive strength, and surface properties of the composition. For instance, the hardness values may be about 2.0 or more, in some embodiments about 2.5 or more, in some embodiments about 3.0 or more, in some embodiments from about 3.0 to about 11.0, in some embodiments from about 3.5 to about 11.0, and in some embodiments, from about 4.5 to about 6.5 based on the Mohs hardness scale.

Any of a variety of different types of mineral particles may generally be employed in the polymer composition, such as those formed from a natural and/or synthetic silicate mineral, such as talc, mica, silica (e.g., amorphous silica), alumina, halloysite, kaolinite, illite, montmorillonite, vermiculite, palygorskite, pyrophyllite, calcium silicate, aluminum silicate, wollastonite, etc.; sulfates; carbonates; phosphates; fluorides, borates; and so forth. Particularly suitable are particles having the desired hardness value, such as calcium carbonate (CaCO₃, Mohs hardness of 3.0), copper carbonate hydroxide (Cu₂CO₃(OH)₂, Mohs hardness of 4.0); calcium fluoride (CaFI₂, Mohs hardness of 4.0); calcium pyrophosphate ((Ca₂P₂O₇, Mohs hardness of 5.0), anhydrous dicalcium phosphate (CaHPO₄, Mohs hardness of 3.5), hydrated aluminum phosphate (AlPO₄·2H2O, Mohs hardness of 4.5); silica (SiO₂, Mohs hardness of 5.0-6.0), potassium aluminum silicate (KAlSi₃O₈, Mohs hardness of 6), copper silicate (CuSiO₃·H₂O, Mohs hardness of 5.0); calcium borosilicate hydroxide (Ca₂B₅SiO₉(OH)₅, Mohs hardness of 3.5); alumina (AlO₂, Mohs hardness of 10.0); calcium sulfate (CaSO₄, Mohs hardness of 3.5), barium sulfate (BaSO₄, Mohs hardness of from 3 to 3.5), mica (Mohs hardness of 2.5-5.3), and so forth, as well as combinations thereof. Mica, for instance, is particularly suitable. Any form of mica may generally be employed, including, for instance, muscovite (KAl₂(AlSi₃)O₁₀(OH)₂), biotite (K(Mg, Fe)₃(AlSi₃)O₁₀(OH)₂), phlogopite (KMg₃(AlSi₃)O₁₀(OH)₂), lepidolite (K(Li, Al)₂₋₃(AlSi₃)O₁₀(OH)₂), glauconite (K, Na)(Al, Mg, Fe)₂(Si, Al)₄O₁₀(OH)₂), etc. Muscovite-based mica is particularly suitable for use in the polymer composition.

In certain embodiments, the mineral particles, such as barium sulfate and/or calcium sulfate particles, may have a shape that is generally granular or nodular in nature. In such embodiments, the particles may have a median size (e.g., diameter) of from about 0.5 to about 20 micrometers, in some embodiments from about 1 to about 15 micrometers, in some embodiments from about 1.5 to about 10 micrometers, and in some embodiments, from about 2 to about 8 micrometers, such as determined using laser diffraction techniques in accordance with ISO 13320:2009 (e.g., with a Horiba LA-960 particle size distribution analyzer). In other embodiments, it may also be desirable to employ flake-shaped mineral particles, such as mica particles, that have a relatively high aspect ratio (e.g., average diameter divided by average thickness), such as about 4 or more, in some embodiments about 8 or more, and in some embodiments, from about 10 to about 500. In such embodiments, the average diameter of the particles may, for example, range from about 5 micrometers to about 200 micrometers, in some embodiments from about 8 micrometers to about 150 micrometers, and in some embodiments, from about 10 micrometers to about 100 micrometers. The average thickness may likewise be about 2 micrometers or less, in some embodiments from about 5 nanometers to about 1 micrometer, and in some embodiments, from about 20 nanometers to about 500 nanometers such as determined using laser diffraction techniques in accordance with ISO 13320:2009 (e.g., with a Horiba LA-960 particle size distribution analyzer). The mineral particles may also have a narrow size distribution. That is, at least about 70% by volume of the particles, in some embodiments at least about 80% by volume of the particles, and in some embodiments, at least about 90% by volume of the particles may have a size within the ranges noted above.

Suitable mineral fibers may likewise include those that are derived from silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Particularly suitable are fibers having the desired hardness value, including fibers derived from inosilicates, such as wollastonite (Mohs hardness of 4.5 to 5.0), which are commercially available from Nyco Minerals under the trade designation Nyglos® (e.g., Nyglos® 4 W or Nyglos® 8). The mineral fibers may have a median width (e.g., diameter) of from about 1 to about 35 micrometers, in some embodiments from about 2 to about 20 micrometers, in some embodiments from about 3 to about 15 micrometers, and in some embodiments, from about 7 to about 12 micrometers. The mineral fibers may also have a narrow size distribution. That is, at least about 60% by volume of the fibers, in some embodiments at least about 70% by volume of the fibers, and in some embodiments, at least about 80% by volume of the fibers may have a size within the ranges noted above. Without intending to be limited by theory, it is believed that mineral fibers having the size characteristics noted above can more readily move through molding equipment, which enhances the distribution within the polymer matrix and minimizes the creation of surface defects. In addition to possessing the size characteristics noted above, the mineral fibers may also have a relatively high aspect ratio (average length divided by median width) to help further improve the mechanical properties and surface quality of the resulting polymer composition. For example, the mineral fibers may have an aspect ratio of from about 2 to about 100, in some embodiments from about 2 to about 50, in some embodiments from about 3 to about 20, and in some embodiments, from about 4 to about 15. The volume average length of such mineral fibers may, for example, range from about 1 to about 200 micrometers, in some embodiments from about 2 to about 150 micrometers, in some embodiments from about 5 to about 100 micrometers, and in some embodiments, from about 10 to about 50 micrometers.

ii. Laser Activatable Additive

Although by no means required, the polymer composition may be “laser activatable” in the sense that it contains an additive that can be activated by a laser direct structuring (“LDS”) process. In such a process, the additive is exposed to a laser that causes the release of metals. The laser thus draws the pattern of conductive elements onto the part and leaves behind a roughened surface containing embedded metal particles. These particles act as nuclei for the crystal growth during a subsequent plating process (e.g., copper plating, gold plating, nickel plating, silver plating, zinc plating, tin plating, etc.). The laser activatable additive generally includes oxide crystals, which may include two or more metal oxide cluster configurations within a definable crystal formation. For example, the overall crystal formation may have the following general formula:

AB₂O₄ or ABO₂

wherein,
A is a metal cation having a valance of 2 or more, such as cadmium, chromium, manganese, nickel, zinc, copper, cobalt, iron, magnesium, tin, titanium, etc., as well as combinations thereof; and
B is a metal cation having a valance of 3 or more, such as antimony, chromium, iron, aluminum, nickel, manganese, tin, etc., as well as combinations thereof.

Typically, A in the formula above provides the primary cation component of a first metal oxide cluster and B provides the primary cation component of a second metal oxide cluster. These oxide clusters may have the same or different structures. In one embodiment, for example, the first metal oxide cluster has a tetrahedral structure and the second metal oxide cluster has an octahedral cluster. Regardless, the clusters may together provide a singular identifiable crystal type structure having heightened susceptibility to electromagnetic radiation. Examples of suitable oxide crystals include, for instance, MgAl₂O₄, ZnAl₂O₄, FeAl₂O₄, CuFe₂O₄, CuCr₂O₄, MnFe₂O₄, NiFe₂O₄, TiFe₂O₄, FeCr₂O₄, MgCr₂O₄, tin/antimony oxides (e.g., (Sb/Sn)O₂), and combinations thereof. Copper chromium oxide (CuCr₂O₄) is particularly suitable for use in the present invention and is available from Shepherd Color Co. under the designation “Shepherd Black 1 GM.” In some cases, the laser activatable additive may also have a core-shell configuration, such as described in WO 2018/130972. In such additives, the shell component of the additive is typically laser activatable, while the core may be any general compound, such as an inorganic compound (e.g., titanium dioxide, mica, talc, etc.).

When employed, laser activatable additives typically constitute from about 0.1 wt. % to about 30 wt. %, in some embodiments from about 0.5 wt. % to about 20 wt. %, and in some embodiments, from about 1 wt. % to about 10 wt. % of the polymer composition. Of course, the polymer composition may also be free (i.e., 0 wt. %) of such laser activatable additives, such as spinel crystals, or such additives may be present in only a small concentration, such as in an amount of about 1 wt. % or less, in some embodiments about 0.5 wt. % or less, and in some embodiments, from about 0.001 wt. % to about 0.2 wt. %.

iii. Glass Fibers

One beneficial aspect of the present invention is that good dielectric properties may be achieved without adversely impacting the mechanical properties of the resulting part. To help ensure that such properties are maintained, it is generally desirable that the polymer composition remains substantially free of conventional fibrous fillers, such as glass fibers. Thus, if employed at all, glass fibers typically constitute no more than about 20 wt. %, in some embodiments no more than about 10 wt. %, in some embodiments no more than about 5 wt. %, and in some embodiments, from about 0.001 wt. % to about 3 wt. % of the polymer composition.

iv. Optional Additives

A wide variety of other additional additives can also be included in the polymer composition, such as lubricants, thermally conductive fillers, pigments, antioxidants, stabilizers, surfactants, waxes, flame retardants, anti-drip additives, nucleating agents (e.g., boron nitride), tribological agents (e.g., fluoropolymers), antistatic fillers (e.g., carbon nanotubes, carbon fibers, ionic liquids, etc.), flow modifiers (e.g., aluminum trihydrate), and other materials added to enhance properties and processability. Lubricants, for example, may be employed in the polymer composition that are capable of withstanding the processing conditions of the liquid crystalline polymer without substantial decomposition. Examples of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N′-ethylenebisstearamide. When employed, the lubricant(s) typically constitute from about 0.05 wt. % to about 1.5 wt. %, and in some embodiments, from about 0.1 wt. % to about 0.5 wt. % (by weight) of the polymer composition.

### II. Formation

The components used to form the polymer composition may be combined together using any of a variety of different techniques as is known in the art. In one particular embodiment, for example, a liquid crystalline polymer, carbon particles, dielectric filler, and other optional additives are melt processed as a mixture within an extruder to form the polymer composition. The mixture may be melt-kneaded in a single-screw or multi-screw extruder at a temperature of from about 250° C. to about 450° C. In one embodiment, the mixture may be melt processed in an extruder that includes multiple temperature zones. The temperature of individual zones is typically set within about −60° C. to about 25° C. relative to the melting temperature of the liquid crystalline polymer. By way of example, the mixture may be melt processed using a twin screw extruder such as a Leistritz 18-mm co-rotating fully intermeshing twin screw extruder. A general purpose screw design can be used to melt process the mixture. In one embodiment, the mixture including all of the components may be fed to the feed throat in the first barrel by means of a volumetric feeder. In another embodiment, different components may be added at different addition points in the extruder, as is known. For example, the liquid crystalline polymer may be applied at the feed throat, and certain additives (e.g., dielectric filler) may be supplied at the same or different temperature zone located downstream therefrom. Regardless, the resulting mixture can be melted and mixed then extruded through a die. The extruded polymer composition can then be quenched in a water bath to solidify and granulated in a pelletizer followed by drying.

In some embodiments, the carbon particles may be added to the composition in the form of a masterbatch that also contains a thermoplastic carrier. In some embodiments, for instance, the carbon particles may constitute from about 5 wt. % to about 70 wt. %, in some embodiments from about 20 wt. % to about 65 wt. %, and in some embodiments, from about 30 wt. % to about 60 wt. % of the masterbatch. Typically, the thermoplastic carrier includes a liquid crystalline polymer, which may be the same or different from other liquid crystalline polymer(s) employed in the polymer matrix. The masterbatch may be blended with the polymer matrix and any optional fillers in an extruder as described above.

### III. Dielectric Layer

Once formed, the polymer composition may be shaped into a dielectric layer for use in a wide variety of devices, such as in an electronic device that employs an antenna system. Due to the beneficial properties of the polymer composition, the dielectric layer typically has a small size, such as a thickness of about 5 millimeters or less, in some embodiments about 4 millimeters or less, and in some embodiments, from about 0.5 to about 3 millimeters. Typically, the dielectric layer is formed using a molding process, such as an injection molding process in which dried and preheated plastic granules are injected into the mold.

The dielectric layer may be particularly suitable for use in an electronic device that employs an antenna system. In one embodiment, for example, the dielectric layer may be a substrate on which is formed one or more antenna elements. The antenna elements may be formed in a variety of ways, such as by plating, electroplating, laser direct structuring, etc. When containing spinel crystals as a laser activatable additive, for instance, activation with a laser may cause a physio-chemical reaction in which the spinel crystals are cracked open to release metal atoms. These metal atoms can act as a nuclei for metallization (e.g., reductive copper coating). The laser also creates a microscopically irregular surface and ablates the polymer matrix, creating numerous microscopic pits and undercuts in which the copper can be anchored during metallization. Antennas of a variety of different types, can be formed on the substrate, such as patch antenna elements, inverted-F antenna elements, closed and open slot antenna elements, loop antenna elements, monopoles, dipoles, planar inverted-F antenna elements, hybrids of these designs, etc. In addition to being employed as a substrate, the dielectric layer may also be employed as a cover that overlies the substrate and antenna resonating element(s). The polymer composition of the present invention may be employed in the substrate, cover, or both. In certain embodiments, it may be desired that the dielectric constant of the substrate is different than the dielectric constant of the cover. In this manner, the resulting antenna system may exhibit increased voltage standing wave radio (“VSWR”), decreased gain, and/or increased bandwidth. For example, the ratio of the dielectric constant of one of the layers to the dielectric constant of another of the layers may be from about 1 to about 20, in some embodiments from about 1.5 to about 10, in some embodiments from about 2 to about 8, and in some embodiments, from about 3 to about 6. In one embodiment, for instance, the substrate has a higher dielectric constant than the cover. In such embodiments, it may be desired to employ the polymer composition of the present invention in the substrate. In another embodiment, the cover has a higher dielectric constant than the substrate. In such embodiments, it may be desired to employ the polymer composition of the present invention in the cover.

The resulting antenna system can be employed in a variety of different electronic components. As an example, the antenna system may be formed in electronic components, such as desktop computers, portable computers, handheld electronic devices, automotive equipment, etc. In one suitable configuration, the antenna system is formed in the housing of a relatively compact portable electronic component in which the available interior space is relatively small. Examples of suitable portable electronic components include cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, etc. The antenna could also be integrated with other components such as camera module, speaker or battery cover of a handheld device.

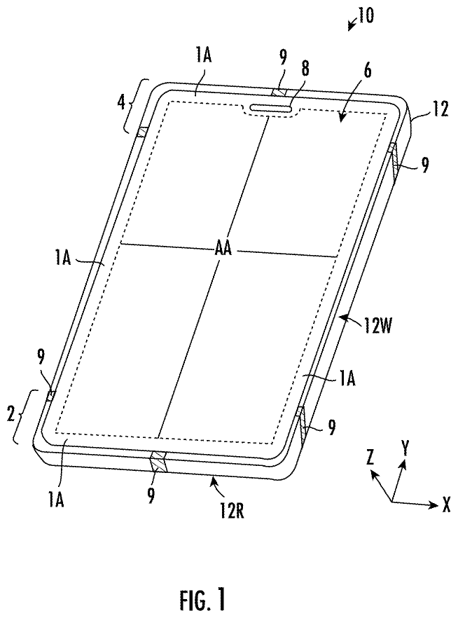

One particularly suitable electronic device is shown in FIG. 1 is a handheld device 10 that may contain wireless circuitry that includes one or more antennas. The antennas may include phased antenna arrays that are used for handling millimeter wave and centimeter wave communications. Millimeter wave communications, which are sometimes referred to as extremely high frequency (EHF) communications, involve signals at 60 GHz or other frequencies between about 30 GHz and 300 GHz. Centimeter wave communications involve signals at frequencies between about 10 GHz and 30 GHz. While uses of millimeter wave communications may be described herein as examples, centimeter wave communications, EHF communications, or any other types of communications may be similarly used. If desired, electronic devices may also contain wireless communications circuitry for handling satellite navigation system signals, cellular telephone signals, local wireless area network signals, near-field communications, light-based wireless communications, or other wireless communications.

The electronic device 10 may be a portable electronic device or other suitable electronic device. For example, the electronic device 10 may be a laptop computer, a tablet computer, a somewhat smaller device such as a wrist-watch device, pendant device, headphone device, earpiece device, or other wearable or miniature device, a handheld device such as a cellular telephone, a media player, or other small portable device. The device 10 may also be a set-top box, a desktop computer, a display into which a computer or other processing circuitry has been integrated, a display without an integrated computer, a wireless access point, wireless base station, an electronic device incorporated into a kiosk, building, or vehicle, or other suitable electronic equipment. The device 10 may include a housing 12, which may sometimes be referred to as a case, may be formed of plastic, glass, ceramics, fiber composites, metal (e.g., stainless steel, aluminum, etc.), other suitable materials, or a combination of these materials. In some situations, parts of the housing 12 may be formed from dielectric or other low-conductivity material (e.g., glass, ceramic, plastic, sapphire, etc.). In other situations, the housing 12 or at least some of the structures that make up housing 12 may be formed from metal elements.

The device 10 may, if desired, have a display 6, which may be mounted on the front face of device 10. The display 6 may be a touch screen that incorporates capacitive touch electrodes or may be insensitive to touch. The rear face of housing 12 (i.e., the face of device 10 opposing the front face of device 10) may have a substantially planar housing wall such as rear housing wall 12R (e.g., a planar housing wall). The rear housing wall 12R may have slots that pass entirely through the rear housing wall and that therefore separate portions of housing 12 from each other. The rear housing wall 12R may include conductive portions and/or dielectric portions. If desired, rear housing wall 12R may include a planar metal layer covered by a thin layer or coating of dielectric such as glass, plastic, sapphire, or ceramic. The housing 12 may also have shallow grooves that do not pass entirely through housing 12. The slots and grooves may be filled with plastic or other dielectric. If desired, portions of housing 12 that have been separated from each other (e.g., by a through slot) may be joined by internal conductive structures (e.g., sheet metal or other metal members that bridge the slot).

The housing 12 may include peripheral housing structures such as peripheral structures 12W. Peripheral structures 12W and conductive portions of rear housing wall 12R may sometimes be referred to herein collectively as “conductive structures” of the housing 12. Peripheral structures 12W may run around the periphery of the device 10 and the display 6. In configurations in which the device 10 and the display 6 have a rectangular shape with four edges, peripheral structures 12W may be implemented using peripheral housing structures that have a rectangular ring shape with four corresponding edges and that extend from rear housing wall 12R to the front face of device 10 (as an example). The peripheral structures 12W or part of peripheral structures 12W may serve as a bezel for display 6 (e.g., a cosmetic trim that surrounds all four sides of display 6 and/or that helps hold display 6 to device 10) if desired. Peripheral structures 12W may, if desired, form sidewall structures for device 10 (e.g., by forming a metal band with vertical sidewalls, curved sidewalls, etc.). The peripheral structures 12W may be formed of a conductive material, such as metal, and may therefore sometimes be referred to as peripheral conductive housing structures, conductive housing structures, peripheral metal structures, peripheral conductive sidewalls, peripheral conductive sidewall structures, conductive housing sidewalls, peripheral conductive housing sidewalls, sidewalls, sidewall structures, or a peripheral conductive housing member (as examples). Peripheral conductive housing structures 12W may be formed from a metal such as stainless steel, aluminum, or other suitable materials. One, two, or more than two separate structures may be used in forming peripheral conductive housing structures 12W.

The display 6 may have an array of pixels that form an active area AA that displays images for a user of device 10. For example, active area AA may include an array of display pixels. The array of pixels may be formed from liquid crystal display (LCD) components, an array of electrophoretic pixels, an array of plasma display pixels, an array of organic light-emitting diode display pixels or other light-emitting diode pixels, an array of electrowetting display pixels, or display pixels based on other display technologies. If desired, active area AA may include touch sensors such as touch sensor capacitive electrodes, force sensors, or other sensors for gathering a user input. The display 6 may also have an inactive border region that runs along one or more of the edges of active area AA. The inactive area IA may be free of pixels for displaying images and may overlap circuitry and other internal device structures in housing 12. To block these structures from view by a user of device 10, the underside of the display cover layer or other layers in display 6 that overlaps inactive area IA may be coated with an opaque masking layer in inactive area IA. The opaque masking layer may have any suitable color.

The display 6 may be protected using a display cover layer such as a layer of transparent glass, clear plastic, transparent ceramic, sapphire, or other transparent crystalline material, or other transparent layer(s). The display cover layer may have a planar shape, a convex curved profile, a shape with planar and curved portions, a layout that includes a planar main area surrounded on one or more edges with a portion that is bent out of the plane of the planar main area, or other suitable shapes. The display cover layer may cover the entire front face of device 10. In another suitable arrangement, the display cover layer may cover substantially all of the front face of device 10 or only a portion of the front face of device 10. Openings may be formed in the display cover layer. For example, an opening may be formed in the display cover layer to accommodate a button. An opening may also be formed in the display cover layer to accommodate ports, such as speaker port 8, or a microphone port. Openings may be formed in housing 12 to form communications ports (e.g., an audio jack port, a digital data port, etc.) and/or audio ports for audio components such as a speaker and/or a microphone if desired.

In regions 2 and 4, openings may be formed within the conductive structures of device 10 (e.g., between peripheral conductive housing structures 12W and opposing conductive ground structures such as conductive portions of rear housing wall 12R, conductive traces on a printed circuit board, conductive electrical components in display 6, etc.). These openings, which may sometimes be referred to as gaps, may be filled with air, plastic, and/or other dielectrics and may be used in forming slot antenna resonating elements for one or more antennas in device 10, if desired. Conductive housing structures and other conductive structures in device 10 may serve as a ground plane for the antennas in device 10. The openings in regions 2 and 4 may serve as slots in open or closed slot antennas, may serve as a central dielectric region that is surrounded by a conductive path of materials in a loop antenna, may serve as a space that separates an antenna resonating element such as a strip antenna resonating element or an inverted-F antenna resonating element from the ground plane, may contribute to the performance of a parasitic antenna resonating element, or may otherwise serve as part of antenna structures formed in regions 2 and 4. If desired, the ground plane that is under active area AA of display 6 and/or other metal structures in device 10 may have portions that extend into parts of the ends of device 10 (e.g., the ground may extend towards the dielectric-filled openings in regions 2 and 4), thereby narrowing the slots in regions 2 and 4.

In general, the device 10 may include any suitable number of antennas (e.g., one or more, two or more, three or more, four or more, etc.), one or more of which may employ the polymer composition of the present invention. The antennas in the device 10 may be located at opposing first and second ends of an elongated device housing (e.g., ends at regions 2 and 4 of device 10 of FIG. 1), along one or more edges of a device housing, in the center of a device housing, in other suitable locations, or in one or more of these locations.

Portions of peripheral conductive housing structures 12W may be provided with peripheral gap structures. For example, peripheral conductive housing structures 12W may be provided with one or more gaps 9, as shown in FIG. 1. The gaps in peripheral conductive housing structures 12W may be filled with dielectric such as polymer, ceramic, glass, air, other dielectric materials, or combinations of these materials. The gaps 9 may divide peripheral conductive housing structures 12W into one or more peripheral conductive segments. There may be, for example, two peripheral conductive segments in peripheral conductive housing structures 12W (e.g., in an arrangement with two of gaps 9), three peripheral conductive segments (e.g., in an arrangement with three of gaps 9), four peripheral conductive segments (e.g., in an arrangement with four of gaps 9), six peripheral conductive segments (e.g., in an arrangement with six gaps 9), etc. The segments of peripheral conductive housing structures 12W that are formed in this way may form parts of antennas in device 10.

In a typical embodiment, the device 10 may have one or more upper antennas and one or more lower antennas (as an example). An upper antenna may, for example, be formed at the upper end of device 10 in region 4. A lower antenna may, for example, be formed at the lower end of device 10 in region 2. The antennas may be used separately to cover identical communications bands, overlapping communications bands, or separate communications bands. The antennas may be used to implement an antenna diversity scheme or a multiple-input-multiple-output (MIMO) antenna scheme. The antennas may be used to support any communications bands of interest. For example, the device 10 may include antenna structures for supporting local area network communications, voice and data cellular telephone communications, global positioning system (GPS) communications or other satellite navigation system communications, Bluetooth® communications, near-field communications, etc. Two or more antennas in the device 10 may be arranged in a phased antenna array for covering millimeter and centimeter wave communications if desired.

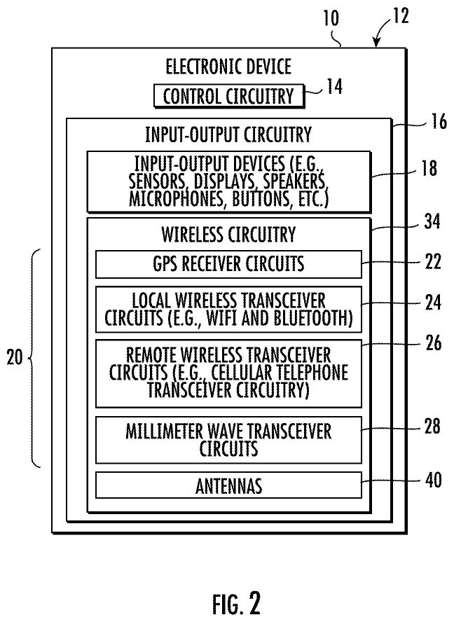

FIG. 2 is a schematic diagram showing illustrative components that may be used in the electronic device 10. As shown, the device 10 may include storage and processing circuitry such as control circuitry 14. Control circuitry 14 may include storage such as hard disk drive storage, nonvolatile memory (e.g., flash memory or other electrically-programmable-read-only memory configured to form a solid-state drive), volatile memory (e.g., static or dynamic random-access-memory), etc. Processing circuitry in control circuitry 14 may be used to control the operation of device 10. This processing circuitry may be based on one or more microprocessors, microcontrollers, digital signal processors, baseband processor integrated circuits, application specific integrated circuits, etc. Control circuitry 14 may be used to run software on device 10, such as internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network protocols (e.g., IEEE 802.11 protocols—sometimes referred to as WiFi®), protocols for other short-range wireless communications links such as the Bluetooth® protocol or other wireless personal area network protocols, IEEE 802.11 ad protocols, cellular telephone protocols, MIMO protocols, antenna diversity protocols, satellite navigation system protocols, etc.

The device 10 may include input-output circuitry 16. Input-output circuitry 16 may include input-output devices 18. Input-output devices 18 may be used to allow data to be supplied to device 10 and to allow data to be provided from device 10 to external devices. Input-output devices 18 may include user interface devices, data port devices, and other input-output components. For example, input-output devices may include touch screens, displays without touch sensor capabilities, buttons, joysticks, scrolling wheels, touch pads, key pads, keyboards, microphones, cameras, speakers, status indicators, light sources, audio jacks and other audio port components, digital data port devices, light sensors, accelerometers or other components that can detect motion and device orientation relative to the Earth, capacitance sensors, proximity sensors (e.g., a capacitive proximity sensor and/or an infrared proximity sensor), magnetic sensors, and other sensors and input-output components.

The input-output circuitry 16 may also include wireless communications circuitry 34 for communicating wirelessly with external equipment. Wireless communications circuitry 34 may include radio-frequency (RF) transceiver circuitry formed from one or more integrated circuits, power amplifier circuitry, low-noise input amplifiers, passive RF components, one or more antennas 40, transmission lines, and other circuitry for handling RF wireless signals. Wireless signals can also be sent using light (e.g., using infrared communications). The wireless communications circuitry 34 may include radio-frequency transceiver circuitry 20 for handling various radio-frequency communications bands. For example, circuitry 34 may include transceiver circuitry 22, 24, 26, and 28.

Transceiver circuitry 24 may be wireless local area network transceiver circuitry. Transceiver circuitry 24 may handle 2.4 GHz and 5 GHz bands for Wi-Fi®. (IEEE 802.11) communications or other wireless local area network (WLAN) bands and may handle the 2.4 GHz Bluetooth® communications band or other wireless personal area network (WPAN) bands. The circuitry 34 may use cellular telephone transceiver circuitry 26 for handling wireless communications in frequency ranges such as a low communications band from 600 to 960 MHz, a midband from 1710 to 2170 MHz, a high band from 2300 to 2700 MHz, an ultra-high band from 3400 to 3700 MHz, or other communications bands between 600 MHz and 4000 MHz or other suitable frequencies (as examples). The circuitry 26 may handle voice data and non-voice data.

Millimeter wave transceiver circuitry 28 (sometimes referred to as extremely high frequency (EHF) transceiver circuitry 28 or transceiver circuitry 28) may support communications at frequencies between about 10 GHz and 300 GHz. For example, transceiver circuitry 28 may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, transceiver circuitry 28 may support communications in an IEEE K communications band between about 18 GHz and 27 GHz, a Kₐ communications band between about 26.5 GHz and 40 GHz, a Ku communications band between about 12 GHz and 18 GHz, a V communications band between about 40 GHz and 75 GHz, a W communications band between about 75 GHz and 110 GHz, or any other desired frequency band between approximately 10 GHz and 300 GHz. If desired, circuitry 28 may support IEEE 802.11 ad communications at 60 GHz and/or 5th generation mobile networks or 5th generation wireless systems (5G) communications bands between 27 GHz and 90 GHz. If desired, circuitry 28 may support communications at multiple frequency bands between 10 GHz and 300 GHz such as a first band from 27.5 GHz to 28.5 GHz, a second band from 37 GHz to 41 GHz, and a third band from 57 GHz to 71 GHz, or other communications bands between 10 GHz and 300 GHz. Circuitry 28 may be formed from one or more integrated circuits (e.g., multiple integrated circuits mounted on a common printed circuit in a system-in-package device, one or more integrated circuits mounted on different substrates, etc.). While circuitry 28 is sometimes referred to herein as millimeter wave transceiver circuitry 28, millimeter wave transceiver circuitry 28 may handle communications at any desired communications bands at frequencies between 10 GHz and 300 GHz (e.g., transceiver circuitry 28 may transmit and receive radio-frequency signals in millimeter wave communications bands, centimeter wave communications bands, etc.).

The antennas 40 in the wireless communications circuitry 34 may be formed using any suitable antenna types. For example, the antennas 40 may include antennas with resonating elements that are formed from loop antenna structures, patch antenna structures, stacked patch antenna structures, antenna structures having parasitic elements, inverted-F antenna structures, slot antenna structures, planar inverted-F antenna structures, monopoles, dipoles, helical antenna structures, surface integrated waveguide structures, hybrids of these designs, etc. If desired, one or more of antennas 40 may be cavity-backed antennas. Different types of antennas may be used for different bands and combinations of bands. For example, one type of antenna may be used in forming a local wireless link antenna and another type of antenna may be used in forming a remote wireless link antenna. Dedicated antennas may be used for receiving satellite navigation system signals or, if desired, antennas 40 can be configured to receive both satellite navigation system signals and signals for other communications bands (e.g., wireless local area network signals and/or cellular telephone signals). Antennas 40 can be arranged in phased antenna arrays for handling millimeter wave and centimeter wave communications.

Transmission line paths may be used to route antenna signals within the device 10. For example, transmission line paths may be used to couple antennas 40 to the transceiver circuitry 20. The transmission line paths in device 10 may include coaxial cable paths, microstrip transmission lines, stripline transmission lines, edge-coupled microstrip transmission lines, edge-coupled stripline transmission lines, waveguide structures for conveying signals at millimeter wave frequencies (e.g., coplanar waveguides or grounded coplanar waveguides), transmission lines formed from combinations of transmission lines of these types, etc. The transmission line paths in device 10 may be integrated into rigid and/or flexible printed circuit boards if desired. In one embodiment, the transmission line paths may include transmission line conductors (e.g., signal and/or ground conductors) that are integrated within multilayer laminated structures (e.g., layers of a conductive material such as copper and a dielectric material such as a resin that are laminated together without intervening adhesive) that may be folded or bent in multiple dimensions (e.g., two or three dimensions) and that maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive). Filter circuitry, switching circuitry, impedance matching circuitry, and other circuitry may be interposed within the transmission lines, if desired.

In some embodiments, the antennas 40 may include antenna arrays (e.g., phased antenna arrays to implement beam steering functions). For example, the antennas that are used in handling millimeter wave signals for extremely high frequency wireless transceiver circuits 28 may be implemented as phased antenna arrays. The radiating elements in a phased antenna array for supporting millimeter wave communications may be patch antennas, dipole antennas, or other suitable antenna elements. The transceiver circuitry 28 can be integrated with the phased antenna arrays to form integrated phased antenna array and transceiver circuit modules or packages (sometimes referred to herein as integrated antenna modules or antenna modules) if desired. In devices such as handheld devices, the presence of an external object such as the hand of a user or a table or other surface on which a device is resting has a potential to block wireless signals such as millimeter wave signals. In addition, millimeter wave communications typically require a line of sight between antennas 40 and the antennas on an external device. Accordingly, it may be desirable to incorporate multiple phased antenna arrays into device 10, each of which is placed in a different location within or on device 10. With this type of arrangement, an unblocked phased antenna array may be switched into use and, once switched into use, the phased antenna array may use beam steering to optimize wireless performance. Similarly, if a phased antenna array does not face or have a line of sight to an external device, another phased antenna array that has line of sight to the external device may be switched into use and that phased antenna array may use beam steering to optimize wireless performance. Configurations in which antennas from one or more different locations in device 10 are operated together may also be used (e.g., to form a phased antenna array, etc.).

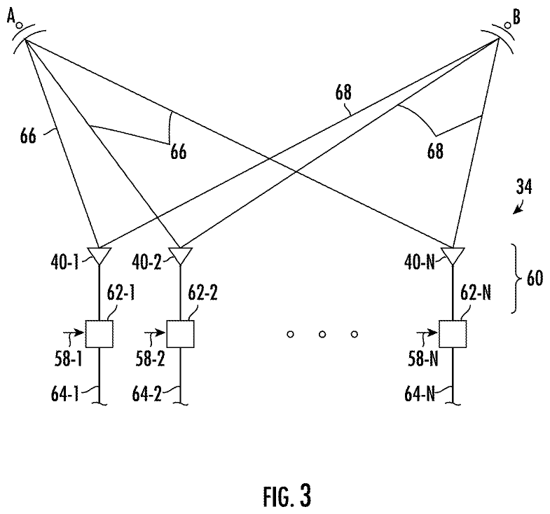

FIG. 3 shows how antennas 40 in the device 10 may be formed in a phased antenna array. As shown in FIG. 3, phased antenna array 60 (sometimes referred to herein as array 60, antenna array 60, or array 60 of antennas 40) may be coupled to signal paths such as transmission line paths 64 (e.g., one or more radio-frequency transmission lines). For example, a first antenna 40-1 in phased antenna array 60 may be coupled to a first transmission line path 64-1, a second antenna 40-2 in phased antenna array 60 may be coupled to a second transmission line path 64-2, an Nth antenna 40-N in phased antenna array 60 may be coupled to an Nth transmission line path 64-N, etc. While antennas 40 are described herein as forming a phased antenna array, the antennas 40 in phased antenna array 60 may sometimes be referred to as collectively forming a single phased array antenna. The antennas 40 in the phased antenna array 60 may be arranged in any desired number of rows and columns or in any other desired pattern (e.g., the antennas need not be arranged in a grid pattern having rows and columns). During signal transmission operations, transmission line paths 64 may be used to supply signals (e.g., radio-frequency signals such as millimeter wave and/or centimeter wave signals) from transceiver circuitry 28 (FIG. 2) to the phased antenna array 60 for wireless transmission to external wireless equipment. During signal reception operations, the transmission line paths 64 may be used to convey signals received at the phased antenna array 60 from external equipment to the transceiver circuitry 28 (FIG. 2).

The use of multiple antennas 40 in the phased antenna array 60 allows beam steering arrangements to be implemented by controlling the relative phases and magnitudes (amplitudes) of the radio-frequency signals conveyed by the antennas. In the example of FIG. 3, for example, the antennas 40 each have a corresponding radio-frequency phase and magnitude controller 62 (e.g., a first phase and magnitude controller 62-1 interposed on transmission line path 64-1 may control phase and magnitude for radio-frequency signals handled by antenna 40-1, a second phase and magnitude controller 62-2 interposed on transmission line path 64-2 may control phase and magnitude for radio-frequency signals handled by antenna 40-2, an Nth phase and magnitude controller 62-N interposed on transmission line path 64-N may control phase and magnitude for radio-frequency signals handled by antenna 40-N, etc.). The phase and magnitude controllers 62 may each include circuitry for adjusting the phase of the radio-frequency signals on transmission line paths 64 (e.g., phase shifter circuits) and/or circuitry for adjusting the magnitude of the radio-frequency signals on transmission line paths 64 (e.g., power amplifier and/or low noise amplifier circuits).

The phase and magnitude controllers 62 may sometimes be referred to collectively herein as beam steering circuitry (e.g., beam steering circuitry that steers the beam of radio-frequency signals transmitted and/or received by phased antenna array 60). The term “beam” or “signal beam” may be used herein to collectively refer to wireless signals that are transmitted and received by phased antenna array 60 in a particular direction. The term “transmit beam” may sometimes be used herein to refer to wireless radio-frequency signals that are transmitted in a particular direction whereas the term “receive beam” may sometimes be used herein to refer to wireless radio-frequency signals that are received from a particular direction. If, for example, the phase and magnitude controllers 62 are adjusted to produce a first set of phases and/or magnitudes for transmitted millimeter wave signals, the transmitted signals will form a millimeter wave frequency transmit beam as shown by beam 66 of FIG. 3 that is oriented in the direction of point A. If, however, the phase and magnitude controllers 62 are adjusted to produce a second set of phases and/or magnitudes for the transmitted millimeter wave signals, the transmitted signals will form a millimeter wave frequency transmit beam as shown by beam 68 that is oriented in the direction of point B. Similarly, if the phase and magnitude controllers 62 are adjusted to produce the first set of phases and/or magnitudes, wireless signals (e.g., millimeter wave signals in a millimeter wave frequency receive beam) may be received from the direction of point A as shown by beam 66. If the phase and magnitude controllers 62 are adjusted to produce the second set of phases and/or magnitudes, signals may be received from the direction of point B, as shown by beam 68. Each phase and magnitude controller 62 may be controlled to produce a desired phase and/or magnitude based on a corresponding control signal 58 received from control circuitry 14 of FIG. 2 or other control circuitry in device 10 (e.g., the phase and/or magnitude provided by phase and magnitude controller 62-1 may be controlled using control signal 58-1, the phase and/or magnitude provided by phase and magnitude controller 62-2 may be controlled using control signal 58-2, etc.). If desired, control circuitry 14 may actively adjust control signals 58 in real time to steer the transmit or receive beam in different desired directions over time. Phase and magnitude controllers 62 may provide information identifying the phase of received signals to control circuitry 14 if desired.

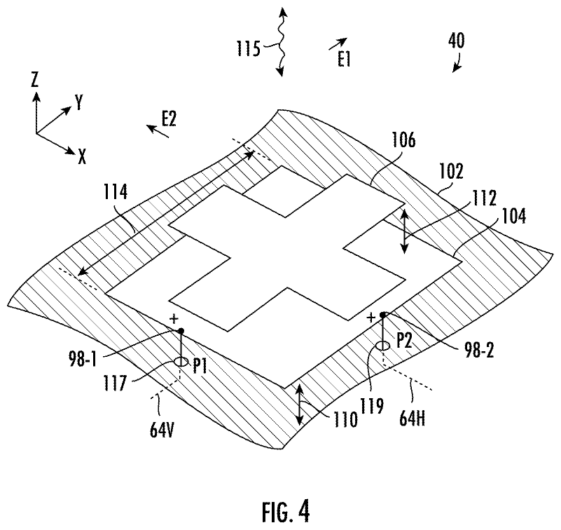

Any desired antenna structures may be used for implementing the antenna 40. In one suitable embodiment, patch antenna structures may be used for the implementing antenna 40. An illustrative patch antenna that may be used in phased antenna array 60 of FIG. 3 is shown in FIG. 4. As shown, the antenna 40 may have a patch antenna resonating element 104 that is separated from and parallel to a ground plane, such as antenna ground plane 102. The patch antenna resonating element 104 may lie within a plane such as the X-Y plane of FIG. 4 (e.g., the lateral surface area of element 104 may lie in the X-Y plane). The ground plane 102 may lie within a plane that is parallel to the plane of patch element 104. The patch element 104 and ground plane 102 may therefore lie in separate parallel planes that are separated by a distance 110. The length of the sides of patch element 104 may be selected so that antenna 40 resonates at a desired operating frequency. For example, the sides of patch element 104 may each have a length 114 that is approximately equal to half of the wavelength of the signals conveyed by antenna 40 (e.g., the effective wavelength given the dielectric properties of the materials surrounding patch element 104). In one suitable arrangement, length 114 may be between 0.8 mm and 1.2 mm (e.g., approximately 1.1 mm) for covering a millimeter wave frequency band between 57 GHz and 70 GHz or between 1.6 mm and 2.2 mm (e.g., approximately 1.85 mm) for covering a millimeter wave frequency band between 37 GHz and 41 GHz, as just two examples.

To enhance the polarizations handled, the antenna 40 may be provided with multiple feeds. As shown, the antenna 40 may have a first feed at antenna port P1 that is coupled to a first transmission line path 64 such as transmission line path 64V and a second feed at antenna port P2 that is coupled to a second transmission line path 64 such as transmission line path 64H. The first antenna feed may have a first ground feed terminal coupled to ground plane 102 (not shown) and a first positive feed terminal 98-1 coupled to patch element 104. The second antenna feed may have a second ground feed terminal coupled to ground plane 102 (not shown) and a second positive feed terminal 98-2 on patch element 104. Openings or holes 117 and/or 119 may be formed in the ground plane 102. Transmission line path 64V may include a vertical conductor (e.g., a conductive through-via, conductive pin, metal pillar, solder bump, combinations of these, or other vertical conductive interconnect structures) that extends through the hole 117 to the positive antenna feed terminal 98-1 on the patch element 104. Transmission line path 64H may include a vertical conductor that extends through the hole 119 to positive the antenna feed terminal 98-2 on patch element 104.

When using the first antenna feed associated with port P1, the antenna 40 may transmit and/or receive radio-frequency signals having a first polarization (e.g., the electric field E1 of antenna signals 115 associated with port P1 may be oriented parallel to the Y-axis in FIG. 4). When using the antenna feed associated with port P2, antenna 40 may transmit and/or receive radio-frequency signals having a second polarization (e.g., the electric field E2 of antenna signals 115 associated with port P2 may be oriented parallel to the X-axis of FIG. 4 so that the polarizations associated with ports P1 and P2 are orthogonal to each other). One of ports P1 and P2 may be used at a given time so that the antenna 40 operates as a single-polarization antenna or both ports may be operated at the same time so that antenna 40 operates with other polarizations (e.g., as a dual-polarization antenna, a circularly-polarized antenna, an elliptically-polarized antenna, etc.). If desired, the active port may be changed over time so that antenna 40 can switch between covering vertical or horizontal polarizations at a given time.

A bandwidth-widening parasitic antenna resonating element, such as a parasitic antenna resonating element 106, may also be employed in the antenna 40. For example, the parasitic antenna resonating element may be formed from conductive structures located at a distance 112 over the patch element 104. The parasitic element 106 is not directly fed, whereas the patch element 104 is directly fed via transmission line paths 64V and 64H and positive antenna feed terminals 98-1 and 98-2. The parasitic element 106 may create a constructive perturbation of the electromagnetic field generated by the patch element 104, creating a new resonance for antenna 40. This may serve to broaden the overall bandwidth of antenna 40 (e.g., to cover the entire millimeter wave frequency band from 57 GHz to 71 GHz). At least some or an entirety of parasitic element 106 may overlap the patch element 104. In the example of FIG. 4, the parasitic element 106 has a cross or “X” shape.

The antenna 40 of FIG. 4 may be formed on a substrate (not shown). If desired, the substrate may be formed from the polymer composition as noted above. The substrate may also include multiple stacked dielectric layers, one or more of which may contain the polymer composition and/or other types of materials, such as fiberglass-filled epoxy, glass, sapphire, ceramic, etc. The ground plane 102, patch element 104, and parasitic element 106 may be formed on different layers of the substrate if desired.

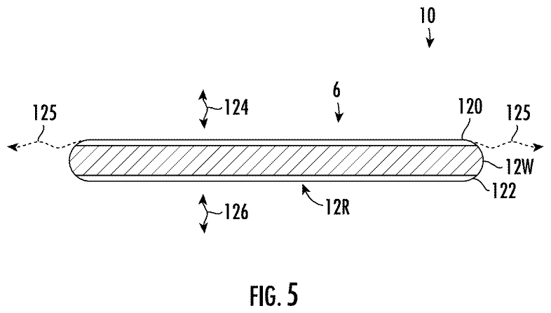

FIG. 5 is a cross-sectional side view of the electronic device 10 showing how the phased antenna array 60 (FIG. 3) may convey radio-frequency signals through a cover layer for the device 10. The plane of the page of FIG. 5 may, for example, lie in the Y-Z plane of FIG. 1. As shown, peripheral conductive housing structures 12W may extend around the periphery of device 10. Peripheral conductive housing structures 12W may extend across the height (thickness) of the device 10 from a first cover layer 120 to a second cover layer 122. If desired, the cover layer 120 may extend across the entire lateral surface area of the device 10 and may form a first (front) face of device 10. The cover layer 122 may extend across the entire lateral surface area of device 10 and may form a second (rear) face of the device 10. In the example of FIG. 5, the cover layer 122 forms a part of rear housing wall 12R for device 10 whereas the cover layer 120 forms a part of display 6 (e.g., a display cover layer for display 6). Active circuitry in the display 6 may emit light through the cover layer 120 and may receive touch or force input from a user through cover layer 120. The cover layer 122 may form a thin dielectric layer or coating under a conductive portion of the rear housing wall 12R (e.g., a conductive backplate or other conductive layer that extends across substantially all of the lateral area of device 10). The cover layers 120 and 122 may be formed from any desired dielectric materials, such as the polymer composition of the present invention, glass, sapphire, ceramic, other polymeric materials, etc.

Conductive structures, such as peripheral conductive housing structures 12W, may block electromagnetic energy conveyed by the phased antenna array 60 of FIG. 3. To allow radio-frequency signals to be conveyed with wireless equipment external to device 10, the phased antenna array 60 may be mounted behind the cover layer 120 and/or cover layer 122. When mounted behind the cover layer 120, the phased antenna array 60 may transmit and receive wireless signals (e.g., wireless signals at millimeter and centimeter wave frequencies) 124 through the cover layer 120. When mounted behind the cover layer 122, the phased antenna array 60 may transmit and receive wireless signals 126 through the cover layer 120.

In practice, radio-frequency signals at millimeter and centimeter wave frequencies, such as radio-frequency signals 124 and 126, may be subject to substantial attenuation, particularly through relatively dense mediums, such as cover layers 120 and 122. The radio-frequency signals may also be subject to destructive interference due to reflections within the cover layers 120 and 122 and may generate undesirable surface waves at the interfaces between cover layers 120 and 122 and the interior of device 10. For example, radio-frequency signals conveyed by a phased antenna array 60 mounted behind cover layer 120 may generate surface waves at the interior surface of cover layer 120. If care is not taken, the surface waves may propagate laterally outward (e.g., along the interior surface of cover layer 120) and may escape out the sides of device 10, as shown by arrows 125. Such surface waves may reduce the overall antenna efficiency for the phased antenna array, may generate undesirable interference with external equipment, and may subject the user to undesirable radio-frequency energy absorption, for example. Similar surface waves can also be generated at the interior surface of cover layer 122.

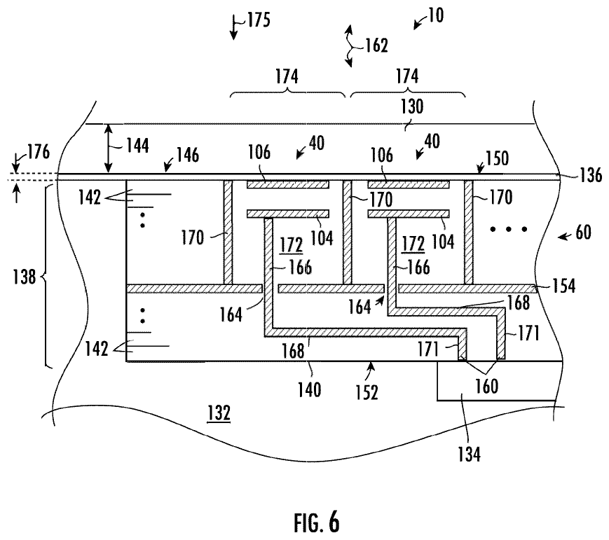

In this regard, FIG. 6 is a cross-sectional side view of the device 10 showing how the phased antenna array 60 may be implemented within the device 10 to mitigate these issues. As shown in FIG. 6, the phased antenna array 60 may be formed on a substrate 140 mounted within the interior 132 of device 10 and against the cover layer 130. The phased antenna array 60 may include multiple antennas 40 (e.g., stacked patch antennas as shown in FIG. 4) arranged in an array of rows-and columns (e.g., a one or two-dimensional array). The cover layer 130 may form a dielectric rear wall for device 10 (e.g., cover layer 130 of FIG. 6 may form cover layer 122 of FIG. 5) or may form a display cover layer for device 10 (e.g., cover layer 130 of FIG. 6 may form cover layer 120 of FIG. 5), as examples. Antennas 40 in the phased array antenna 60 may be mounted at a surface of substrate 140 or may be partially or completely embedded within substrate 140 (e.g., within a single layer of substrate 140 or within multiple layers of substrate 140).

In the example of FIG. 6, antennas 40 in the phased antenna array 60 include a ground plane (e.g., ground plane 102 of FIG. 4) and patch elements 104 that are formed from conductive traces embedded within layers 142 of substrate 140. The ground plane for phased antenna array 60 may be formed from conductive traces 154 within substrate 140, for example. Antennas 40 in the phased antenna array 60 may include parasitic elements 106 (e.g., cross-shaped parasitic elements as shown in FIG. 4) that are formed from conductive traces at surface 150 of substrate 140. For example, parasitic elements 106 may be formed from conductive traces on the top-most layer 142 of substrate 140. In another suitable arrangement, one or more layers 142 may be interposed between parasitic elements 106 and the cover layer 130. In yet another suitable arrangement, parasitic elements 106 may be omitted and patch elements 104 may be formed from conductive traces at surface 150 of the substrate 140 (e.g., patch elements 104 may be in direct contact with adhesive layer 136 or interior surface 146 of cover layer 130).

The surface 150 of the substrate 140 may be mounted against (e.g., attached to) the interior surface 146 of the cover layer 130. For example, the substrate 140 may be mounted to the cover layer 130 using an adhesive layer 136. Of course, if desired, the substrate 140 may also be affixed to the cover layer 130 using other adhesives, screws, pins, springs, conductive housing structures, etc. Likewise, the substrate 140 need not be affixed to the cover layer 130. The parasitic elements 106 in the phased antenna array 60 may be in direct contact with the interior surface 146 of cover layer 130 (e.g., in scenarios where adhesive layer 136 is omitted or where adhesive layer 136 has openings that align with parasitic elements 106) or may be coupled to interior surface 146 by adhesive layer 136 (e.g., parasitic elements 106 may be in direct contact with adhesive layer 136).

The phased array antenna 60 and the substrate 140 may sometimes be referred to herein collectively as antenna module 138. If desired, transceiver circuitry 134 (e.g., transceiver circuitry 28 of FIG. 2) or other transceiver circuits may be mounted to antenna module 138 (e.g., at surface 152 of substrate 140 or embedded within substrate 140).

If desired, a conductive layer (e.g., a conductive portion of rear housing wall 12R when cover layer 130 forms cover layer 122 of FIG. 5) may also be formed on the interior surface 146 of the cover layer 130. In these scenarios, the conductive layer may provide structural and mechanical support for the device 10 and may form a part of the antenna ground plane for device 10. The conductive layer may have an opening that is aligned with the phased antenna array 60 and/or antenna module 138 (e.g., to allow radio-frequency signals 162 to be conveyed through the conductive layer).

Conductive traces 154 may sometimes be referred to herein as ground traces 154, ground plane 154, antenna ground 154, or ground plane traces 154. The layers 142 in the substrate 140 between ground traces 154 and the cover layer 130 may sometimes be referred to herein as antenna layers 142. The layers in the substrate 140 between ground traces 154 and the surface 152 of the substrate 140 may sometimes be referred to herein as transmission line layers. The antenna layers may be used to support patch elements 104 and parasitic elements 106 of the antennas 40 in the phased antenna array 60. The transmission line layers may be used to support transmission line paths (e.g., transmission line paths 64V and 64H of FIG. 4) for the phased antenna array 60.

Transceiver circuitry 134 may include transceiver ports 160. Each transceiver port 160 may be coupled to a respective antenna 40 over one or more corresponding transmission line paths 64 (e.g., transmission line paths such as transmission line paths 64H and 64V of FIG. 4). Transmission line paths for antennas 40 may be embedded within the transmission line layers of substrate 140. The transmission line paths may include conductive traces 168 within the transmission line layers of substrate 140 (e.g., conductive traces on one or more dielectric layers 142 within substrate 140). Conductive traces 168 may form a signal conductor and/or ground conductor of one or more of the transmission line paths 64 for the antennas 40 in the phased antenna array 60. If desired, additional grounded traces within the transmission line layers of substrate 140 and/or portions of ground traces 154 may form a ground conductor for one or more transmission line paths 64. The conductive traces 168 may be coupled to the positive antenna feed terminals of antennas 40 (e.g., positive antenna feed terminals 98-1 and 98-2 of FIG. 4) over vertical conductive structures 166. Conductive traces 168 may be coupled to transceiver ports 160 over vertical conductive structures 171. Vertical conductive structures 166 may extend through a portion of the transmission line layers of substrate 140, holes or openings 164 in ground traces 154 (e.g., holes such as holes 117 and 119 of FIG. 4), and the antenna layers in substrate 140 to patch elements 104. Vertical conductive structures 171 may extend through a portion of the transmission line layers in substrate 140 to transceiver ports 160.

If care is not taken, radio-frequency signals transmitted by antennas 40 in the phased antenna array 60 may reflect off of the interior surface 146, thereby limiting the gain of the phased antenna array 60 in some directions. Mounting conductive structures from the antennas 40 (e.g., patch elements 104 or parasitic elements 106) directly against the interior surface 146 (e.g., either through adhesive layer 136 or in direct contact with interior surface 146) may serve to minimize these reflections, thereby optimizing antenna gain for phased antenna array 60 in all directions. The adhesive layer 136 may have a selected thickness 176 that is sufficiently small so as to minimize these reflections while still allowing for a satisfactory adhesion between cover layer 130 and substrate 140. As an example, the thickness 176 may be between 300 microns and 400 microns, between 200 microns and 500 microns, between 325 microns and 375 microns, between 100 microns and 600 microns, etc.

The substrate 140 and/or the cover layer 130 may be formed from the polymer composition of the present invention, as well as from other types of materials, such as glass, sapphire, ceramic, other polymeric materials, etc. In certain embodiments, it may be desired that the dielectric constant of the cover layer is different than the dielectric constant of the substrate such as noted above. For example, the ratio of the dielectric constant of the cover layer 130 to the dielectric constant of the substrate 140 may be from about 1 to about 10, in some embodiments from about 2 to about 8, and in some embodiments, from about 3 to about 6. In such embodiments, it may be desired to employ the polymer composition of the present invention in the cover layer 130. In another embodiment, the ratio of the dielectric constant of the substrate 140 to the dielectric constant of the cover layer 130 may be from about 1 to about 20, in some embodiments from about 1.5 to about 10, in some embodiments from about 2 to about 8, and in some embodiments, from about 3 to about 6. In such embodiments, it may be desired to employ the polymer composition of the present invention in the substrate 140. Such a difference in dielectric constants can help mitigate destructive interference effects. For example, the dielectric constant of the cover layer 130 and thickness 144 of the cover layer 130 may be selected so that cover layer 130 forms a quarter wave impedance transformer for the phased antenna array 60. When configured in this way, the cover layer 130 may optimize matching of the antenna impedance for the phased antenna array 60 to the free space impedance external to device 10 and may mitigate destructive interference within cover layer 130. The thickness 144 of the cover layer 130 may be selected to be between 0.15 and 0.25 times the effective wavelength of operation of phased antenna array 60 in the material used to form the cover layer 130 (e.g., approximately one-quarter of the effective wavelength). The effective wavelength is given by dividing the free space wavelength of operation of the phased antenna array 60 (e.g., a centimeter or millimeter wavelength corresponding to a frequency between 10 GHz and 300 GHz) by a constant factor (e.g., the square root of the dielectric constant of the material used to form cover layer 130). This example is merely illustrative and, if desired, the thickness 144 may be selected to be between 0.17 and 0.23 times the effective wavelength, between 0.12 and 0.28 times the effective wavelength, between 0.19 and 0.21 times the effective wavelength, between 0.15 and 0.30 times the effective wavelength, etc. In practice, thickness 144 may be between 0.8 mm and 1.0 mm, between 0.85 mm and 0.95 mm, or between 0.7 mm and 1.1 mm, as examples. The adhesive layer 136 may be formed from dielectric materials having a dielectric constant that is less than the dielectric constant of the cover layer 130.

Each antenna 40 may be separated from the other antennas 40 in the phased antenna array 60 by vertical conductive structures, such as conductive vias 170. Sets or fences of conductive vias 170 may laterally surround each antenna 40 in the phased antenna array 60. Conductive vias 170 may extend through substrate 140 from surface 150 to ground traces 156. Conductive landing pads (not shown) may be used to secure conductive vias 170 to each layer 142 as the conductive vias pass through substrate 140. By shorting conductive vias 170 to the ground traces 154, the conductive vias 170 may be held at the same ground or reference potential as the ground traces 154. As shown in FIG. 6, the patch element 104 and parasitic element 106 of each antenna 40 in the phased antenna 60 may be mounted within a corresponding volume 172 (sometimes referred to herein as cavity 172). The edges of volume 172 for each antenna 40 may be defined by the conductive vias 170, ground traces 154, and cover layer 130 (e.g., volume 172 for each antenna 40 may be enclosed by conductive vias 170, ground traces 154, and cover layer 130. In this way, conductive vias 170 and ground traces 154 may form a conductive cavity for each antenna 40 in the phased antenna array 60 (e.g., each antenna 40 in phased antenna array 60 may be a cavity-backed stacked patch antenna having a conductive cavity formed from conductive vias 170 and ground traces 154). Each antenna 40 in the phased antenna array 60, its corresponding conductive vias 170, its corresponding volume 172, and its corresponding portion of ground traces 154 may sometimes be referred to herein as an antenna unit cell 174. Antenna unit cells 174 in the phased antenna array 60 may be arranged in any desired pattern (e.g., a pattern having rows and/or columns or other shapes). Some conductive vias 170 may be shared by adjacent antenna unit cells 174 if desired.

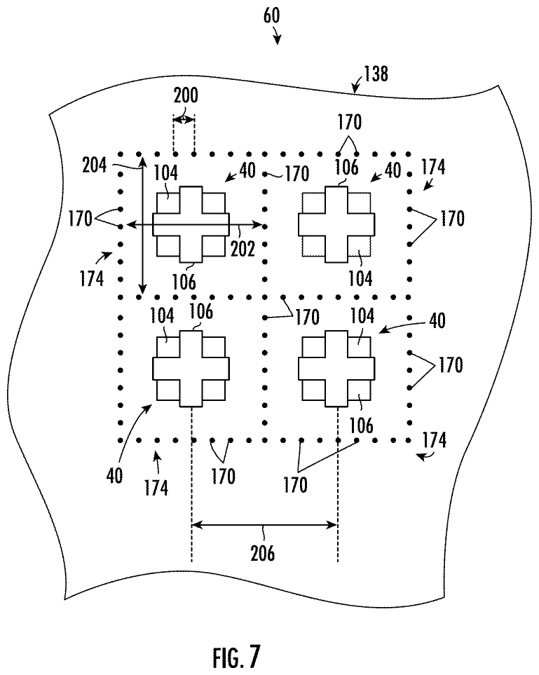

FIG. 7 is a top-down view of the phased antenna array 60 (e.g., as taken in the direction of arrow 175 of FIG. 6). As shown, the phased antenna array 60 on antenna module 138 may include multiple antenna unit cells 174 arranged in a rectangular grid pattern of rows and columns. Each antenna unit cell 174 may include a respective antenna 40 that is laterally surrounded by corresponding set of conductive vias 170 (e.g., corresponding fences of conductive vias 170). The fences of conductive vias 170 for each antenna unit cell 174 may be opaque at frequencies covered by antennas 40. Each conductive via 170 may be separated from two adjacent conductive vias 170 by a distance (pitch) 200. To be opaque at the frequencies covered by antennas 40, the distance 200 may be less than about ⅛ of the wavelength of operation of antennas 40 (e.g., an effective wavelength after compensating for the dielectric effects of substrate 140 of FIG. 6). Each antenna 40 in the phased antenna array 60 may be separated from one or more adjacent antennas 40 in the phased antenna array 60 by distance 206. The distance 206 may be, for example, approximately equal to one-half of the wavelength of operation of antennas 40 (e.g., an effective wavelength given the dielectric properties of substrate 140 of FIG. 6). In the example of FIG. 7, each antenna unit cell 174 has a rectangular periphery defined by conductive vias 170. For example, each antenna unit cell 174 may have a first rectangular dimension 204 and a second rectangular dimension 202. The dimension 202 may be equal to dimension 204 (e.g., each antenna unit cell 174 may have a square outline) or dimension 202 may be different from dimension 204. Dimensions 202 and 204 may be selected so that the antennas 40 in the phased antenna array 60 are separated by approximately one-half of the effective wavelength of operations of antennas 40. As an example, dimensions 202 and 204 may be between 3.0 and 5.0 mm, between 2.0 and 6.0 mm, between 2.5 and 5.5 mm, etc.

The present invention may be better understood with reference to the following examples.

### Test Methods

Melt Viscosity: The melt viscosity (Pa-s) may be determined in accordance with ISO 11443:2021 at a shear rate of 400 s⁻¹ or 1,000 s⁻¹ and temperature 15° C. above the melting temperature (e.g., about 325° C.) using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod may be 233.4 mm.

Melting Temperature: The melting temperature (“Tm”) may be determined by differential scanning calorimetry (“DSC”) as is known in the art. The melting temperature is the differential scanning calorimetry (DSC) peak melt temperature as determined by ISO 11357-3:2018. Under the DSC procedure, samples were heated and cooled at 20° C. per minute as stated in ISO Standard 10350 using DSC measurements conducted on a TA Q2000 Instrument.

Deflection Temperature Under Load (“DTUL”): The deflection under load temperature may be determined in accordance with ISO 75-2:2013 (technically equivalent to ASTM D648). More particularly, a test strip sample having a length of 80 mm, thickness of 10 mm, and width of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO Test No. 75-2:2013).

Tensile Modulus, Tensile Stress, and Tensile Elongation: Tensile properties may be tested according to ISO 527:2019 (technically equivalent to ASTM D638). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus, Flexural Stress, and Flexural Elongation: Flexural properties may be tested according to ISO 178:2019 (technically equivalent to ASTM D790). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO 179-1:2010 (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C.

Dielectric Constant (“Dk”) and Dissipation Factor (“Df”): The dielectric constant (or relative static permittivity) and dissipation factor are determined using a known split-post dielectric resonator technique, such as described in Baker-Jarvis, et al., IEEE Trans. on Dielectric and Electrical Insulation, 5(4), p. 571 (1998) and Krupka, et al., Proc. 7^{th} International Conference on Dielectric Materials: Measurements and Applications, IEEE Conference Publication No. 430 (September 1996). More particularly, a plaque sample having a size of 80 mm×80 mm×1 mm was inserted between two fixed dielectric resonators. The resonator measured the permittivity component in the plane of the specimen. Five (5) samples are tested and the average value is recorded. The split-post resonator can be used to make dielectric measurements in the low gigahertz region, such as 5 GHz. For higher frequencies (e.g., 12 GHz), a split cavity dielectric resonator technique may be used. A PNA (programmable network analyzer, Keysight P9374A) and) and split cavity (GDK) are employed with a plaque sample having a size of 80 mm×80 mm×1 mm. Three (3) samples are tested and the average value is recorded

Heat Cycle Test: Specimens are placed in a temperature control chamber and heated/cooled within a temperature range of from −30° C. and 100° C. Initially, the samples are heated until reaching a temperature of 100° C., when they were immediately cooled. When the temperature reaches −30° C., the specimens are immediately heated again until reaching 100° C. Twenty three (23) heating/cooling cycles may be performed over a 3-hour time period.

Surface/Volume Resistivity: The surface and volume resistivity values may be determined in accordance with IEC 62631-3-1:2016 or ASTM D257-14. According to this procedure, a standard specimen (e.g., 1 meter cube) is placed between two electrodes. A voltage is applied for sixty (60) seconds and the resistance is measured. The surface resistivity is the quotient of the potential gradient (in V/m) and the current per unit of electrode length (in A/m), and generally represents the resistance to leakage current along the surface of an insulating material. Because the four (4) ends of the electrodes define a square, the lengths in the quotient cancel and surface resistivities are reported in ohms, although it is also common to see the more descriptive unit of ohms per square. Volume resistivity is also determined as the ratio of the potential gradient parallel to the current in a material to the current density. In SI units, volume resistivity is numerically equal to the direct-current resistance between opposite faces of a one-meter cube of the material (ohm-m or ohm-cm).

### Comparative Examples 1-3

Comparative Examples 1-3 are formed from various combinations of liquid crystalline polymers (LCP 1 and LCP 2), titanium dioxide particles (chloride-process rutile containing alumina and hydrophobic organic surface treatment, average particle size of 0.27 μm), glass fibers, aluminum trihydrate, and carbon particles (Carbon Black 1) as set forth below in Table 1.

TABLE 1

| | Comp. Ex. 1 | Comp. Ex. 2 | Comp. Ex. 3 |
|---|---|---|---|
| LCP 1 | 44.5 | 39.5 | 34.5 |
| LCP 2 | — | 4 | 8 |
| Titanium Dioxide | 40 | 40 | 40 |
| Glass Fibers | 15 | 15 | 15 |
| Carbon Black 1 | — | 1 | 2 |
| Aluminum Trihydrate | 0.5 | 0.5 | 0.5 |

LCP 1 is formed from 43% HBA, 20% NDA, 9% TA, and 28% HQ. LCP 2 is formed from 60% HBA, 5% HNA, 12.5% BP, 17.5% TA, and 5% APAP (“LCP 2”). Carbon Black 1 was introduced into the composition by initially compounding the particles with LCP 2 to form a masterbatch (20 wt. % carbon black particles and 80 wt. % LCP 2), and then compounding the masterbatch with the remaining components using an 18-mm single screw extruder. Parts are then injection molded from the samples into plaques (60 mm×60 mm).

### Examples 1-5

Examples 1-5 are formed from various combinations of LCP 1, titanium dioxide particles (chloride-process rutile containing alumina and hydrophobic organic surface treatment, average particle size of 0.27 μm), calcium titanate (random-shaped particles, “Calcium Titanate 1”), glass fibers, aluminum trihydrate, lubricant, and carbon black particles (Carbon Black 2) as set forth below in Table 2.

TABLE 2

| | 1 | 2 | 3 | 4 | 5 |
|---|---|---|---|---|---|
| LCP 1 | 42 | 44.5 | 44.2 | 41.7 | 39.2 |
| Titanium Dioxide | 40 | — | 50 | 50 | 50 |
| Calcium Titanate 1 | — | 50 | — | — | — |
| Glass Fibers | 15 | — | — | — | — |
| Carbon Black 2 | 2.5 | 5 | 5 | 7.5 | 10 |
| Aluminum Trihydrate | 0.5 | 0.5 | 0.5 | 0.5 | 0.5 |
| Lubricant | — | — | 0.3 | 0.3 | 0.3 |

The carbon black particles number average primary particle size of 41 nm and a number average secondary particle size of 22 μm. Carbon Black 2 was introduced into the composition by initially compounding the particles with LCP 1 to form a masterbatch (50 wt. % carbon black particles and 50 wt. % LCP 2), and then compounding the masterbatch with the remaining components using an 18-mm single screw extruder. The surface resistivity of the masterbatch was measured to be 7.7×10⁵ ohms (measured with an injection molded disc having a thickness of 3 mm and diameter of 4 mm). Parts are then injection molded from the samples into plaques (60 mm×60 mm).

Comparative Examples 1-3 and Examples 1-5 were tested for electrical, thermal, and mechanical properties. The results are set forth below in Table 3.

TABLE 3

| | Sample | | | | | | | |
|---|---|---|---|---|---|---|---|---|
| | Comp. | Comp. | Comp. | | | | | |
| | Ex. 1 | Ex. 2 | Ex. 3 | 1 | 2 | 3 | 4 | 5 |
| Dielectric Constant | 5.37 | 6.39 | 6.90 | 6.57 | 9.10 | 8.9 | 9.9 | 11.6 |
| (5 GHz) | | | | | | | | |
| Dielectric Constant | — | — | | — | — | 8.6 | 9.5 | 11.0 |
| (12 GHz) | | | | | | | | |
| Dissipation Factor | 0.00348 | 0.00498 | 0.00738 | 0.00412 | 0.0072 | 0.0049 | 0.0084 | 0.0134 |
| (5 GHz) | | | | | | | | |
| Dissipation Factor | — | — | — | — | — | 0.0044 | 0.0067 | 0.0110 |
| (12 GHz) | | | | | | | | |
| DTUL at 1.8 MPa (° C.) | 282 | 273 | 263 | 278 | — | 228 | 226 | 218 |
| Charpy Notched (kJ/m²) | 24 | 19 | 15 | 17 | — | 10 | 12 | 3.3 |
| Tensile Strength (MPa) | 133 | 121 | 114 | 116 | — | 123 | 120 | 100 |
| Tensile Modulus (MPa) | 14,812 | 14,200 | 14,151 | 14,669 | — | 9,441 | 9,980 | 9,764 |
| Tensile Elongation (%) | 1.29 | 1.13 | 1.06 | 1.05 | — | 2.85 | 2.37 | 1.91 |
| Flexural Strength (MPa) | 196 | 180 | 177 | 178 | — | 154 | 156 | 145 |
| Flexural Modulus (MPa) | 14,248 | 14,047 | 13,903 | 14,225 | — | 9,658 | 10,167 | 9,970 |
| Flexural Elongation (%) | 1.93 | 1.68 | 1.67 | 1.65 | — | >3.5 | >3.5 | >3.5 |
| Melt Viscosity | — | — | — | — | 36.7 | 53.0 | 61.5 | 74.3 |
| (Pa-s) at 1,000 s⁻¹ | | | | | | | | |
| Melting Temperature | — | — | — | — | 304.8 | 318.4 | 318.1 | 317.2 |
| (° C., 1^{st} heat of DSC) | | | | | | | | |

### Comparative Examples 4-5

Comparative Examples 4-5 are formed from various combinations of LCP 1, aluminum trihydrate, Calcium Titanate 1, and Carbon Black MB 1 as set forth below in Table 4.

TABLE 4

| | Comp. Ex. 4 | Comp. Ex. 5 |
|---|---|---|
| LCP 1 | 37.5 | 27.5 |
| LCP 2 | 17.6 | 17.6 |
| Calcium Titanate 1 | 40 | 50 |
| Carbon Black 1 | 4.4 | 4.4 |
| Aluminum Trihydrate | 0.5 | 0.5 |

Carbon Black 1 was introduced into the composition by initially compounding the particles with LCP 2 to form a masterbatch (20 wt. % carbon black particles and 80 wt. % LCP 2), and then compounding the masterbatch with the remaining components using an 18-mm single screw extruder. Parts are then injection molded from the samples into plaques (60 mm×60 mm).

### Examples 6-12

Examples 6-12 are formed from various combinations of LCP 1, titanium dioxide particles (chloride-process rutile containing alumina and hydrophobic organic surface treatment, average particle size of 0.27 μm), Calcium Titanate 1, calcium titanate particles (spherical shaped, “Calcium Titanate 2”), aluminum trihydrate, lubricant, and Carbon Black 2 as set forth below in Table 5.

TABLE 5

| | 6 | 7 | 8 | 9 | 10 | 11 | 12 |
|---|---|---|---|---|---|---|---|
| LCP 1 | 42.95 | 42.95 | 42.95 | 42.95 | 37.95 | 42.95 | 42.95 |
| Titanium Dioxide | 50 | 40 | 30 | 20 | 55 | 40 | 30 |
| Calcium Titanate 1 | — | — | — | — | — | 10 | 20 |
| Calcium Titanate 2 | — | 10 | 20 | 30 | — | — | — |
| Carbon Black 2 | 6.25 | 6.25 | 6.25 | 6.25 | 6.25 | 6.25 | 6.25 |
| Aluminum Trihydrate | 0.5 | 0.5 | 0.5 | 0.5 | 0.5 | 0.5 | 0.5 |
| Lubricant | 0.3 | 0.3 | 0.3 | 0.3 | 0.3 | 0.3 | 0.3 |

Carbon Black 2 was introduced into the composition by initially compounding the particles with LCP 1 to form a masterbatch (50 wt. % carbon black particles and 50 wt. % LCP 2), and then compounding the masterbatch with the remaining components using an 18-mm single screw extruder. The surface resistivity of the masterbatch was measured to be 7.7×10⁵ ohms (measured with an injection molded disc having a thickness of 3 mm and diameter of 4 mm). Parts are then injection molded from the samples into plaques (60 mm×60 mm).

Comparative Examples 4-5 and Examples 6-12 were tested for electrical, thermal, and mechanical properties. The results are set forth below in Table 6.

TABLE 6

| | Sample | | | | | | | | |
|---|---|---|---|---|---|---|---|---|---|
| | Comp. | Comp. | | | | | | | |
| | Ex. 4 | Ex. 5 | 6 | 7 | 8 | 9 | 10 | 11 | 12 |
| Dielectric Constant | 6.6 | 8.3 | 9.6 | 9.3 | 9.7 | 9.8 | 10.3 | 9.6 | 9.6 |
| (5 GHz) | | | | | | | | | |
| Dissipation Factor | 0.00314 | 0.00357 | 0.00677 | 0.00739 | 0.0113 | 0.0113 | 0.00779 | 0.00614 | 0.00648 |
| (5 GHz) | | | | | | | | | |
| DTUL at 1.8 MPa (° C.) | — | — | 232 | 219 | — | — | 232 | — | — |
| Charpy Notched (kJ/m²) | — | — | 6 | — | — | — | 6 | 2.1 | 1.8 |
| Tensile Strength (MPa) | — | — | 123 | 34 | — | — | 115 | 81 | 61 |
| Tensile Modulus (MPa) | — | — | 10119 | 7485 | — | — | 10506 | 8296 | 8010 |
| Tensile Elongation (%) | — | — | 2.48 | 0.48 | — | — | 2.36 | 1.55 | 0.98 |
| Flexural Strength (MPa) | — | — | 156 | 75 | — | — | 159 | 125 | 95 |
| Flexural Modulus (MPa) | — | — | 9914 | 7789 | — | — | 10530 | 8412 | 8082 |
| Flexural Elongation (%) | — | — | 3.24 | 1.14 | — | — | 3.19 | 2.43 | 1.53 |
| Melt Viscosity | 22.5 | 61.1 | 67.6 | 33.7 | 29.6 | 35.6 | 81.7 | 63.7 | 67.6 |
| (Pa-s) at 1,000 s⁻¹ | | | | | | | | | |
| Melting Temperature | 310.02 | — | 318.36 | 318.3 | 312.38 | 306.3 | 318.17 | 317.79 | 317.76 |
| (° C., 1^{st} heat of DSC) | | | | | | | | | |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A polymer composition comprising:
100 parts by weight of a polymer matrix that contains a thermotropic liquid crystalline polymer;
from about 8 to about 30 parts by weight of carbon particles;
from about 80 to about 220 parts by weight of a dielectric filler;
wherein the polymer composition exhibits a dissipation factor of about 0.02 or less as determined at a frequency of 5 GHz and a dielectric constant of about 8.5 or more as determined at a frequency of 5 GHz.

2. The polymer composition of claim 1, wherein the carbon particles include carbon black particles.

3. The polymer composition of claim 1, wherein the carbon particles exhibit a surface resistivity of about 1×10² ohms or greater.

4. The polymer composition of claim 1, wherein the carbon black particles have a number average primary particle size from about 5 nm to about 100 nm.

5. The polymer composition of claim 1, wherein the polymer matrix contains a high naphthenic thermotropic liquid crystalline polymer that includes repeating units derived from naphthenic hydroxycarboxylic and/or dicarboxylic acids in an amount of about 10 mol. % or more.

6. The polymer composition of claim 5, wherein the high naphthenic thermotropic liquid crystalline polymer contains repeating units derived from one or more aromatic dicarboxylic acids, one or more aromatic hydroxycarboxylic acids, or a combination thereof.

7. The polymer composition of claim 6, wherein the aromatic hydroxycarboxylic acids include 4-hydroxybenzoic acid, 6-hydroxy-2-naphthoic acid, or a combination thereof.

8. The polymer composition of claim 6, wherein the aromatic dicarboxylic acids include terephthalic acid, isophthalic acid, 2,6-naphthalenedicarboxylic acid, or a combination thereof.

9. The polymer composition of claim 6, wherein the high naphthenic thermotropic liquid crystalline polymer further contains repeating units derived from one or more aromatic diols.

10. The polymer composition of claim 9, wherein the aromatic diols include hydroquinone, 4,4′-biphenol, or a combination thereof.

11. The polymer composition of claim 1, wherein the thermotropic liquid crystalline polymer is wholly aromatic.

12. The polymer composition of claim 1, wherein the thermotropic liquid crystalline polymer contains repeating units derived from 6-hydroxy-2-naphthoic acid in an amount of from about 40 mol. % to about 60 mol. %.

13. The polymer composition of claim 1, wherein the thermotropic liquid crystalline polymer contains repeating units derived from naphthalene-2,6-dicarboxylic acid in an amount from about 15 mol. % to about 30 mol. %.

14. The polymer composition of claim 1, wherein the dielectric filler has a dielectric constant of about 50 or more as determined at a frequency of 1 MHz.

15. The polymer composition of claim 1, wherein the dielectric filler includes titanium dioxide particles.

16. The polymer composition of claim 15, wherein the titanium dioxide particles are in a rutile form.

17. The polymer composition of claim 16, wherein the titanium dioxide particles contain a surface treatment that includes alumina.

18. The polymer composition of claim 1, wherein the dielectric filler contains calcium titanate.

19. The polymer composition of claim 1, wherein the composition is free of glass fibers.

20. The polymer composition of claim 1, wherein the polymer matrix constitutes from about 20 wt. % to about 70 wt. % of the polymer composition, the carbon particles constitute from about 3 wt. % to about 20 wt. % of the polymer composition, and/or the dielectric filler constitute from about 10 wt. % to about 65 wt. % of the polymer composition.

21. The polymer composition of claim 1, wherein the polymer composition has a melting temperature of from about 280° C. to about 400° C.

22. The polymer composition of claim 1, wherein the polymer composition exhibits a melt viscosity of from about 0.1 to about 100 Pa-s as determined at a shear rate of 1,000 s⁻¹ and a temperature of about 15° C. about greater than a melting temperature of the polymer composition.

23. An electronic device comprising a dielectric layer, wherein the dielectric layer comprises the polymer composition of claim 1.

24. The electronic device of claim 23, wherein one or more conductive elements are formed on a surface of the dielectric layer.

25. An antenna system comprising a substrate on which is disposed antenna elements and a cover that overlies the substrate and the antenna elements, wherein the substrate, cover, or both comprise the polymer composition of claim 1.

26. The antenna system of claim 25, wherein the substrate includes the polymer composition.

27. The antenna system of claim 26, wherein the ratio of the dielectric constant of the substrate to the dielectric constant of the cover is from about 1 to about 10.

28. The antenna system of claim 25, wherein the cover comprises the polymer composition.

29. The antenna system of claim 28, wherein the ratio of the dielectric constant of the cover to the dielectric constant of the substrate is from about 1 to about 10.

30. The antenna system of claim 25, wherein the antenna system includes at least one phase array antenna.

31. An electronic device comprising the antenna system of claim 25.

32. The electronic device of claim 31, wherein the device is a cellular telephone.
